(19) United States
(12) Patent Application Publication
(10) Pub. No.: US 2025/0225869 A1
(43) Pub. Date: Jul. 10, 2025

(54) DISPLAY CONTROL DEVICE AND DISPLAY CONTROL PROGRAM

(71) Applicant: DENSO CORPORATION, Kariya-city (JP)

(72) Inventors: Takuya KUME, Kariya-city (JP); Shota IBARA, Kariya-city (JP); Yoshihiro KOZAWA, Kariya-city (JP); Shingo SHIBATA, Kariya-city (JP); Kazuki IZUMI, Kariya-city (JP)

(21) Appl. No.: 19/096,424

(22) Filed: Mar. 31, 2025

Related U.S. Application Data
(63) Continuation of application No. PCT/JP2023/033640, filed on Sep. 15, 2023.

(30) Foreign Application Priority Data
Oct. 17, 2022 (JP) 2022-166454

(51) Int. Cl. G08G 1/0967; B60K 35/23; B60K 35/28; B60K 35/81; G06T 11/20; G08G 1/16

(52) U.S. Cl. CPC G08G 1/096733; B60K 35/23; B60K 35/28; B60K 35/81; G06T 11/203; B60K 2360/166; B60K 2360/176; B60K 2360/179; G08G 1/16

(57) ABSTRACT

A display control device or a non-transitory computer-readable storage medium storing a display control program grasps information of an oncoming vehicle that is a passing target on a narrow road, causes a head-up display to perform overlapping display of a first assistance image with a foreground of a subject vehicle, the first assistance image assisting a driver in lateral position adjustment, and displays, on a screen display device, an external environment image in which a second assistance image that assists passing overlaps with a capture image.

### CROSS REFERENCE TO RELATED APPLICATIONS

The present application is a continuation application of International Patent Application No. PCT/JP2023/033640 filed on Sep. 15, 2023, which designated the U.S. and claims the benefit of priority from Japanese Patent Application No. 2022-166454 filed on Oct. 17, 2022. The entire disclosures of all of the above applications are incorporated herein by reference.

### TECHNICAL FIELD

The present disclosure relates to a display control technology used for vehicles.

### BACKGROUND

In a comparative example, a driving assistance device determines whether passing assistance is necessary when two vehicles are traveling on a narrow road with almost no space for passing each other. When the driving assistance device determines that assistance is necessary, it controls the display to show an image captured by a side camera that captures an area in the periphery of tires close to a passenger seat, the area being in a driver's blind spot.

### SUMMARY

A display control device or a non-transitory computer-readable storage medium storing a display control program grasps information of an oncoming vehicle that is a passing target on a narrow road, causes a head-up display to perform overlapping display of a first assistance image with a foreground of a subject vehicle, the first assistance image assisting a driver in lateral position adjustment, and displays, on a screen display device, an external environment image in which a second assistance image that assists passing overlaps with a capture image.

### BRIEF DESCRIPTION OF THE DRAWINGS

FIG. 1 is a diagram showing an overall of an in-vehicle network including an HCU according to a first embodiment of the present disclosure.

FIG. 2 is a block diagram showing an example of a functional unit constructed in an HCU together with related configurations.

FIG. 3 is a diagram showing an example of a transition display when switching from a normal mode display to a narrow road mode display.

FIG. 4 is a diagram showing an example of an animation displayed by the HUD when starting and ending the narrow road mode.

FIG. 5 is a diagram showing details of an overlapping guide display used for narrow road driving assistance.

FIG. 6 is a diagram showing details of a non-overlapping guide display used for narrow road driving assistance.

FIG. 7 is a diagram showing details of a lateral position adjustment assistance image in which a non-overlapping guide is displayed.

FIG. 8 is a diagram showing a series of narrow road driving assistance displays in detail together with FIGS. 9 to 11.

FIG. 9 is a diagram showing details of a series of narrow road driving assistance displays together with FIGS. 8, 10 and 11.

FIG. 10 is a diagram showing details of a series of narrow road driving assistance displays together with FIGS. 8, 9 and 11.

FIG. 11 is a diagram showing details of a series of narrow road driving assistance displays together with FIGS. 8 to 10.

FIG. 12 is a diagram illustrating details of a process for adjusting an overlapping position of a road edge guide line, a part (A) shows the road edge guide line that overlaps under a normal state, a part (B) shows the road edge guide line that overlaps when an alley is connected to a road edge, parts (C) and (D) show the road edge guide line that overlaps when the alley is a one-way street, a part (E) shows the road edge guide line that overlaps when a vehicle is detected entering the alley, and a part (F) shows the road edge guide line that overlaps when parked vehicles are lined up.

FIG. 13 is a diagram illustrating details of a process for determining the complexity of the road edge.

FIG. 14 is a diagram showing details of the HUD display when the logical end is in a complex situation, together with a normal display.

FIG. 15 is a diagram showing details of the display by the HUD when the behavior of the oncoming vehicle is unstable.

FIG. 16 is a diagram showing details of the HUD display when the speed of an oncoming vehicle is high, together with a normal display.

FIG. 17 is a diagram showing details of a notification display for notifying completion of the lateral position adjustment when the speed of the oncoming vehicle is high, the notification display being changed depending on the size of the oncoming vehicle, a part (A) shows a display when the oncoming vehicle is smaller than a subject vehicle, a part (B) shows a display when the oncoming vehicle is the same type of vehicle as the subject vehicle, and a part (C) shows a display when the oncoming vehicle is larger than the subject vehicle.

FIG. 18 is a diagram showing an example of an animation displayed when the narrow road mode is temporarily canceled and then resumed.

FIG. 19 is a diagram showing an example of an animation displayed when the narrow road mode is cancelled due to a subject vehicle speed limit.

FIG. 20 is a diagram showing an example of an animation displayed when the narrow road mode is cancelled due to bad weather.

FIG. 21 is a diagram showing details of narrow road assistance display by the HUD when driver drowsiness or fatigue is detected.

FIG. 22 is a diagram showing an example of a curve traveling assistance display performed on a curve without a center line.

FIG. 23 is a diagram showing details of the display control process for implementing the narrow road assistance display together with FIG. 24.

FIG. 24 is a diagram showing details of the display control process for implementing the narrow road assistance display together with FIG. 23.

FIG. 25 is a diagram showing details of a periphery monitoring image displayed in a first modification.

### DETAILED DESCRIPTION

In order to smoothly pass other vehicles on narrow roads, it is important to move vehicles outward at an early stage and generate a state in advance for them to pass each other. However, while the driving assistance device of the comparative example provides assistance when passing an oncoming vehicle, it does not provide assistance in generating a state where the vehicle can pass another oncoming vehicle in advance. As a result, there is a difficulty that vehicles will not be able to pass each other smoothly.

One example of the present disclosure provides a display control device and a display control program that enable a driver to smoothly pass other vehicles.

In these aspects, when the oncoming vehicle, which is the passing target, is detected, a first assistance image for assisting the vehicle in moving toward the outside of the narrow road (in other words, for assisting lateral position adjustment) overlaps with the foreground of the vehicle by the head-up display. Therefore, the driver can use the first assistance image to prepare in advance for passing another vehicle without taking the line of sight off the road. Furthermore, the driver can start passing the oncoming vehicle by shifting the line of sight to the external image displayed on the screen display and using the second assistance image that assists passing while checking the actual image in the periphery of the subject vehicle. As described above, by providing assistance through displays in stages, it becomes possible for the driver to pass other vehicles smoothly.

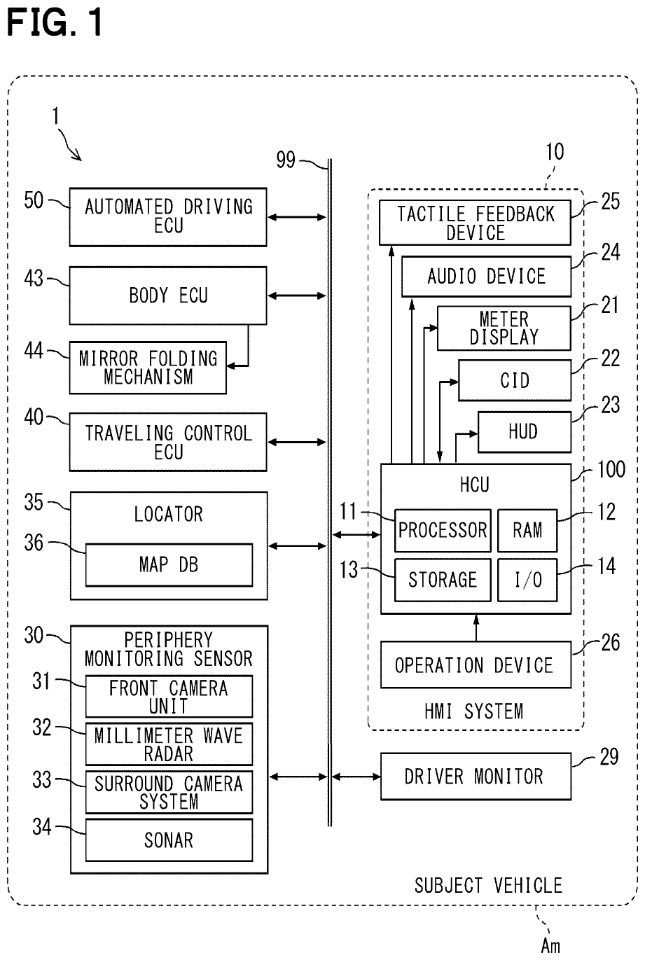

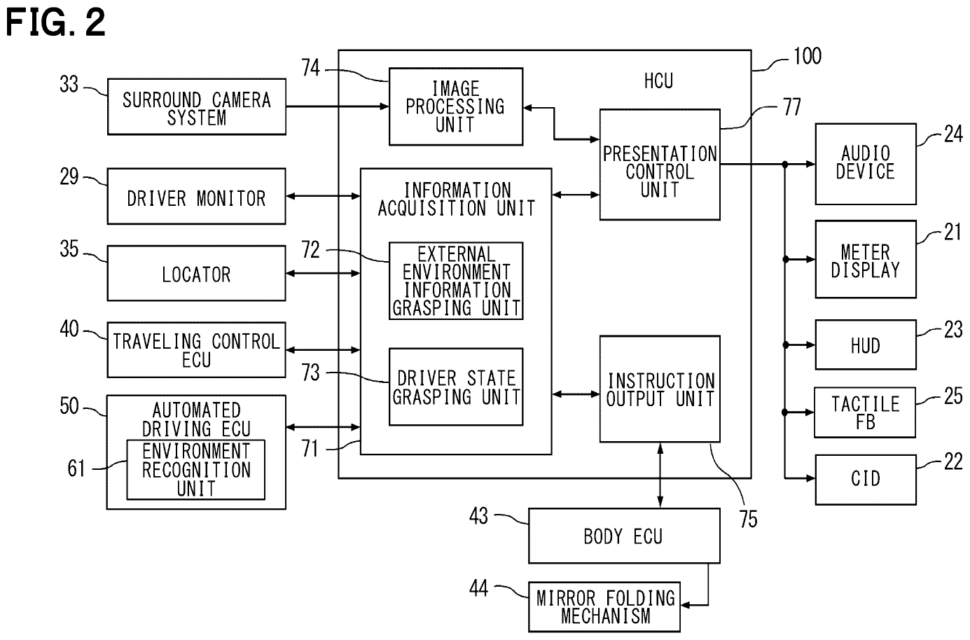

An HCU (Human Machine Interface Control Unit) 100 according to an embodiment of the present disclosure shown in FIGS. 1 and 2 is an interface control device used in a vehicle (hereinafter referred to as subject vehicle Am). The HCU 100 configures a human machine interface (HMI) system 10 of the subject vehicle Am together with multiple input/output devices and the like. The HMI system 10 has an input interface function that accepts an operation by an occupant such as a driver of the subject vehicle Am, and an output interface function that presents information to a driver and the like.

The HCU 100 is communicably connected to a communication bus 99 of an in-vehicle network 1 mounted on the subject vehicle Am. The HCU 100 is one of nodes connected to the in-vehicle network 1. A driver monitor 29, a periphery monitoring sensor 30, a locator 35, a traveling control electronic control unit (ECU) 40, a body ECU 43, an automated driving ECU 50, and the like are connected to the communication bus 99 of the in-vehicle network 1. The multiple nodes connected to the communication bus 99 can communicate with one another. It should be noted that specific nodes among the multiple devices and the multiple ECUs and the like may be directly electrically connected with one another and can communicate with one other without using the communication bus 99.

The driver monitor 29 includes a near-infrared light source, a near-infrared camera, and a control unit that controls them. The driver monitor 29 is installed, for example, to an upper surface of a steering column, an upper surface of an instrument panel, or the like to have a posture such that the near-infrared camera is directed to a headrest of the driver's seat. The driver monitor 29 captures, using the near-infrared camera, an image of the head of the driver, which is irradiated with near-infrared light by the near-infrared light source. An image captured by the near-infrared camera is subjected to image analysis by the control unit. The control unit extracts information such as the driver's eye point position and sight line direction from the captured image, and provides the extracted driver state information (hereinafter, driver status information) to the HCU 100 and the like via the communication bus 99.

The periphery monitoring sensor 30 is an autonomous sensor that monitors a peripheral environment of the subject vehicle Am. The periphery monitoring sensor 30 includes, for example, a front camera unit 31, a millimeter wave radar 32, a surround camera system 33, and a sonar 34. The periphery monitoring sensor 30 may further include other types of sensors, such as a lidar. The periphery monitoring sensor 30 can detect a mobile object and a stationary object in a detection range at the periphery of the subject vehicle. The periphery monitoring sensor 30 provides detection information of objects in the periphery of the subject vehicle to the automated driving ECU 50 and the like.

The periphery monitoring sensor 30 sequentially provides, to the HCU 100, video data consisting of images captured by the surround camera system 33 (hereinafter, referred to as camera images CP, see FIGS. 5 to 7). The surround camera system 33 includes a front camera, a rear camera, a left lateral camera, and a right lateral camera. The surround camera system captures an image of a road surface in the periphery of the subject vehicle Am. Each camera captures an image of the exterior of a subject vehicle Am and the road surface in the periphery of the subject vehicle, which are in the driver's blind spot.

The locator 35 includes a GNSS (global navigation satellite systems) receiver, an inertial sensor, and the like. The locator 35 combines positioning signals received from multiple positioning satellites by the GNSS receiver, a measurement result of the inertial sensor, vehicle speed information output to the communication bus 99, and the like, and sequentially measures a subject vehicle position, a traveling direction, and the like of the subject vehicle Am. The locator 35 sequentially outputs, as locator information, the position information and the direction information of the subject vehicle Am based on a positioning result to the communication bus 99.

The locator 35 further has a map database (hereinafter referred to as map DB) 36 that stores map data. The map DB 36 mainly includes a large-capacity storage medium storing a large number of pieces of three-dimensional map data and two-dimensional map data. The three-dimensional map data is also known as high definition (HD) map, and includes road information necessary for the automated driving. The locator 35 may update the three-dimensional map data and the two-dimensional map data to the latest information by external communication using the in-vehicle communication device. The locator 35 reads map data of the area in the periphery of the current position from the map DB 36, and provides it to the automated driving ECU 50, the HCU 100, and the like together with locator information.

The travel control ECU 40 is an electronic control unit mainly including a microcontroller. The travel control ECU 40 has at least functions of a brake control ECU, a drive control ECU, and a steering control ECU. The travel control ECU 40 continuously performs braking force control for each wheel, output control of the in-vehicle power source, and steering angle control based on operation commands based on the driver's driving operations or control commands from the automated driving ECU 50. In addition, the travel control ECU 40 sequentially outputs to the communication bus 99 vehicle status information indicating the current state of the subject vehicle Am, such as vehicle speed information indicating the travel speed and steering angle information indicating the steering wheel angle (or actual steering angle).

The body ECU 43 is an electronic control unit that mainly includes a microcontroller. The body ECU 43 has a function of controlling lighting devices, doors, seats, mirrors, and the like mounted on the subject vehicle Am. The body ECU 43 is electrically connected to, for example, a mirror folding mechanism 44. The mirror folding mechanism 44 is configured to automatically fold and unfold the left and right door mirrors of the subject vehicle Am. The body ECU 43 outputs a control signal to the mirror folding mechanism 44 to cause the mirror folding mechanism 44 to fold and unfold each door mirror.

The automated driving ECU 50 enables advanced driving assistance of about level 2 or partial automated driving at automated driving levels defined by the Society of Automotive Engineers. The automated driving ECU 50 enables eyes-on automated driving that requires the driver to visually monitor the periphery of the subject vehicle. The automated driving ECU 50 implements the driving assistance function, for example, an adaptive cruise control (i.e., ACC), a lane tracking assist (i.e., LTA), and a lane change assist (i.e., LCA). The automated driving ECU 50 may be capable of performing eyes-off automated driving in which the driver does not need to monitor the periphery, in other words, automated driving of level 3 or higher.

The automated driving ECU 50 is a computer mainly including a control circuit including a processor, a RAM, a storage, an I/O interface, a bus connecting them, and the like. The automated driving ECU 50 has an environment recognition unit 61 as a functional unit for implementing the driving assistance function or the automated driving function.

The environment recognition unit 61 combines the locator information and the map data acquired from the locator 35 with the detection information acquired from the periphery monitoring sensor 30 to recognize the traveling environment of the subject vehicle Am. The environment recognition unit 61 recognizes the road environment on which the subject vehicle Am is traveling based on the locator information and map data. Furthermore, the environment recognition unit 61 grasps the relative positions and relative speeds of static or dynamic targets in the periphery of the subject vehicle Am, such as other vehicles traveling in the periphery of the subject vehicle Am, based on the detection information. The environment recognition unit 61 provides the HCU 100 with road information relating to the road environment and target information relating to targets in the periphery of the subject vehicle.

Next, the multiple display devices, an audio device 24, a tactile feedback device 25, an operation device 26, and the HCU 100 included in the HMI system 10 will be described in detail in order.

A front-rear direction and a left-right direction described below are defined with reference to the subject vehicle Am that is stationary on a horizontal surface. Specifically, the front-rear direction is defined along the longitudinal direction of the subject vehicle Am, and the front is the traveling direction of the subject vehicle Am, which is the depth direction as seen by the driver. The left-right direction is defined along a width direction of the subject vehicle Am. Further, a upper-lower direction is defined along a direction vertical to the horizontal plane that defines the front-rear direction and the left-right direction.

The multiple display devices include a meter display 21, a center information display (hereinafter referred to as CID) 22, a head-up display (hereinafter referred to as HUD) 23, and the like. The plurality of display devices may further include displays of an electronic mirror system. The meter display 21, the CID 22, and the HUD 23 present information through driver's visual perception.

The meter display 21 and the CID 22 are a screen display unit mainly including, for example, a liquid crystal display or an OLED (Organic Light Emitting Diode) display. The meter display 21 and the CID 22 display various images on display screens in a real image manner based on control signals and image data acquired from the HCU 100. The meter display 21 is installed in front of the driver's seat, for example. The CID 22 is installed above a center cluster, for example. The CID 22 has a touch panel function, and detects, for example, touch operations and swipe operations executed by the driver on the display screen or the like.

The HUD 23 projects light of an image formed in front of the driver onto a projection region defined on a windshield or the like based on control signals and image data acquired from the HCU 100. Light of the image reflected to the vehicle interior side by the windshield is perceived by the driver seated on the driver's seat. In this way, the HUD 23 displays a virtual image in the space in front of the projection area. The driver visually recognizes the virtual image in the angle of view displayed by the HUD 23 in an overlapping manner with the foreground of the subject vehicle Am.

The HUD 23 displays the overlapping content and the non-overlapping content as virtual images. The overlapping content is an AR display object used for augmented reality (hereinafter referred to as “AR”) display. The display position of the overlapping content is associated with a specific overlapping target existing in the foreground, such as the road surface, a front vehicle, a pedestrian, and a road sign. The overlapping content is movable as viewed by the driver, as if it were fixed relative to the overlapping target. On the other hand, the non-overlapping content is a non-AR display object that is displayed in the overlapping manner in the foreground, excluding the overlapping content. The non-overlapping content is displayed as being fixed relative to a vehicle feature, such as the windshield, without tracking any particular overlapping target.

The audio device 24 includes speakers installed in a vehicle compartment in an arrangement in the periphery of the driver seat, and outputs a notification sound, a voice message, or the like from the speakers in the vehicle compartment. The tactile feedback device 25 is provided on a steering wheel or the like. The tactile feedback device 25 presents information to the driver gripping the steering wheel through the sense of touch by operating an actuator that generates vibrations.

The operation device 26 is an input portion that receives an operation of user, such as a driver or the like. To the operation device 26, for example, user operations related to activation and deactivation of driving assistance functions, user operations related to display content, and the like are input. The operation device 26 includes a steering switch provided on a spoke portion of a steering wheel, an operation lever provided on a steering column portion, a voice input device that recognizes utterance content of the driver, and the like.

The HCU 100 is an information presentation device that integrally controls information presentation using the multiple display devices, the audio device 24, and the tactile feedback device 25. The HCU 100 is a computer mainly including a control circuit. The control circuit includes a processor 11, a RAM 12, a storage 13, an input and output interface 14, a bus connecting these units, and the like. The processor 11 executes various types of processing for presentation control processing by accessing the RAM 12. The RAM 12 may include a video RAM for generating video data. The storage 13 includes a non-volatile storage medium. The storage 13 stores various programs (display control programs, etc.) to be executed by the processor 11. The HCU 100 constructs multiple functional units for implementing the display control method according to the present disclosure by executing a program stored in the storage 13 using the processor 11. In the HCU 100, functional units such as an information acquisition unit 71, an image processing unit 74, an instruction output unit 75, and a presentation control unit 77 are constructed.

The information acquisition unit 71 is connected to the communication bus 99 so as to communicate information. The information acquisition unit 71 acquires information output to the communication bus 99 by each ECU. The information acquisition unit 71 has an external environment information grasping unit 72 and a driver state grasping unit 73 as sub-functional units for processing information acquired from the communication bus 99.

The external environment information grasping unit 72 acquires locator information and map data provided by the locator 35, road information and target information provided by the environment recognition unit 61, and the vehicle status information provided by the travel control ECU 40. The target information includes position information of the dividing lines and road edges ER of the road on which the vehicle is traveling. The external environment information grasping unit 72 grasps the situation of the road on which the subject vehicle Am is traveling, the situation of the objects in the periphery of the subject vehicle, and the traveling state of the subject vehicle Am based on the various types of acquired information.

The external environment information grasping unit 72 determines whether the subject vehicle Am enters or exits a narrow road in relation to the narrow road driving assistance described later. The narrow road is a narrow street that has no center line and is only slightly wider than two vehicles. On the narrow road, it becomes difficult to pass an oncoming vehicle Ao (see FIG. 5, and the like). The external environment information grasping unit 72 uses at least one of the map data provided by the locator 35 and the detection information from the front camera unit 31 to determine whether the road currently being traveled or the road to be traveled is narrow. The external environment information grasping unit 72 grasps the width of the road ahead of the subject vehicle. When the road width is smaller (narrower) than the narrow road threshold, it determines that the road is a narrow road. The narrow road threshold may be changed depending on the size (vehicle width) of the subject vehicle Am. For example, the larger the size of the subject vehicle Am, the larger the narrow road threshold is set to. In addition, the user of the subject vehicle Am may be able to adjust the narrow road threshold, for example, between “wide”, “medium”, and “narrow”.

When the subject vehicle Am is traveling on a narrow road, the external environment information grasping unit 72 grasps the type and relative position of objects in front of the subject vehicle, specifically, static objects such as utility poles and road signs, as well as the type, relative position and relative speed of dynamic objects such as pedestrians, cyclists, and oncoming vehicles Ao. When the subject vehicle Am is traveling on the narrow road, the external environment information grasping unit 72 grasps information about the oncoming vehicle Ao that is a passing target.

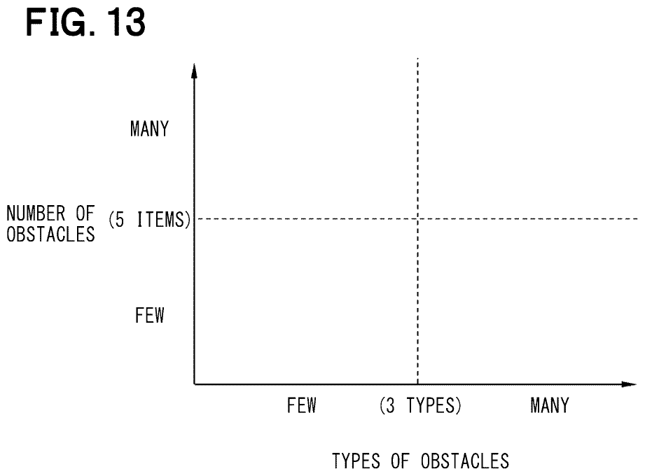

The external environment information grasping unit 72 grasps the situation of the outer road edge ER on the narrow road. The outward direction is the direction opposite, in the width direction, to the oncoming vehicle Ao that is the passing target. Specifically, when the vehicle travels on the left lane of the road, the left direction of the subject vehicle Am is the outward direction. When the vehicle travels on the right lane of the road, the right direction of the subject vehicle Am is the outward direction. The external environment information grasping unit 72 counts the number and types of obstacles present within a predetermined distance (for example, about 100 meters) in front of the subject vehicle Am, considering targets present near the road edge ER (see FIG. 5, and the like) to the outside of the subject vehicle Am as obstacles. The external environment information grasping unit 72 determines that the road edge ER is in a complex situation when the number of obstacles present near the road edge with respect to the subject vehicle Am is a predetermined number (for example, five or more), or when the number of types of obstacles is a predetermined number (for example, three or more) (see FIG. 13). The external environment information grasping unit 72 may determine that the road edge ER is in the complex state when the number of obstacles is equal to or greater than a predetermined number and the number of types of obstacles is equal to or greater than a predetermined number.

The driver state grasping unit 73 recognizes the state of the driver based on the driver status information obtained from the driver monitor 29. The driver state grasping unit 73 grasps the driver's drowsiness and fatigue. The driver state grasping unit 73 determines whether the driver's line of sight is directed toward a display device such as the meter display 21, the CID 22, or the HUD 23, based on the driver's line of sight direction.

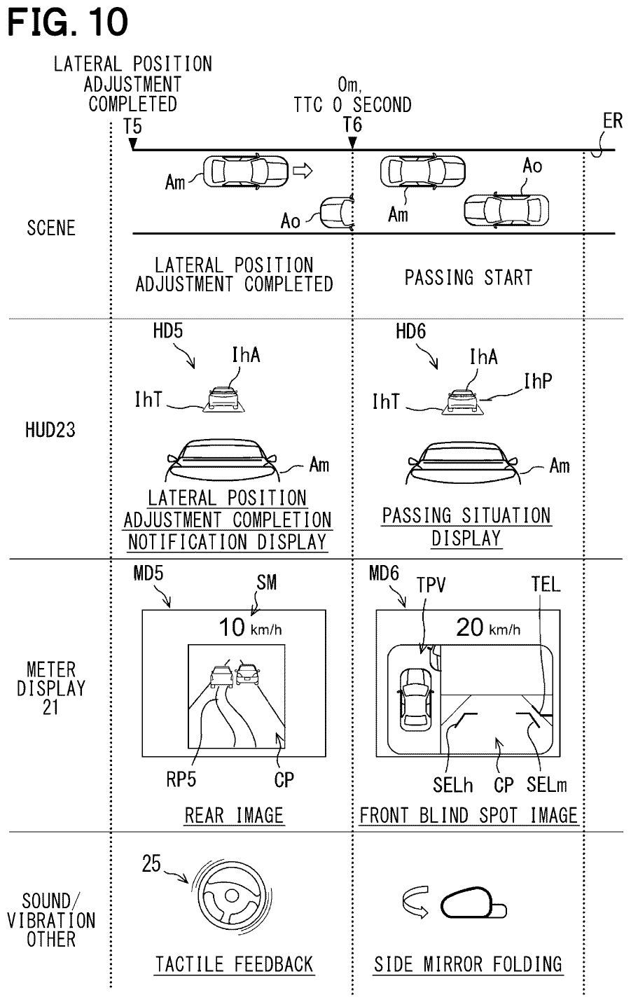

When an image of the periphery of the subject vehicle is displayed on the meter display 21 or the CID 22, the image processing unit 74 requests the surround camera system 33 to provide image data. The image processing unit 74 acquires video data output by each camera of the surround camera system 33 and performs image processing for displaying the data on the meter display 21 or the CID 22. As an example, the image processing unit 74 combines the image data from each camera to generate a virtual viewpoint image (top-view image TPV, see FIG. 10) shown in a top-down manner with respect to the road surface in the periphery of the subject vehicle Am from directly above the subject vehicle Am. The image processing unit 74 provides the image data from each camera and the virtual viewpoint image to the presentation control unit 77. At least a part of the image processing functions implemented in the image processing unit 74 may be provided in the controller of the surround camera system 33. In this embodiment, the image processing unit 74 can acquire a virtual viewpoint image generated by the surround camera system 33.

The instruction output unit 75 outputs an instruction signal to an in-vehicle device not included in the HMI system 10. Thereby, it is possible to enable the in-vehicle device to operate together with the presentation of information. The instruction output unit 75 transmits an instruction signal requesting the storage and deployment of the side mirrors of the subject vehicle Am to the body ECU 43. Based on the instruction signal received from the instruction output unit 75, the body ECU 43 cooperates with the mirror folding mechanism 44 to perform the operation of folding the door mirrors and the operation of returning the folded door mirrors to their original position.

The presentation control unit 77 comprehensively provides information to the driver using the audio device 24, the tactile feedback device 25, and each display device. The presentation control unit 77 is based on the information acquired by the information acquisition unit 71 to enable the presentation of information according to the traveling state of the subject vehicle Am and the traveling environment in the periphery of the subject vehicle. The presentation control unit 77 controls the reproduction of a notification sound by the audio device 24 and the implementation of steering vibration by the tactile feedback device 25. The presentation control unit 77 controls the display by each display device by generating control signals and video data that are sequentially output to each display device.

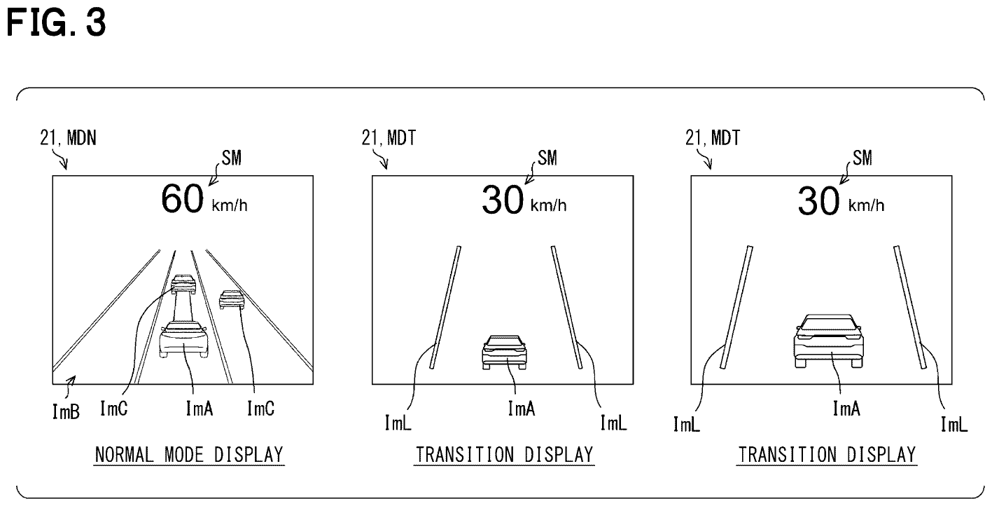

The HCU 100 described above provides step-by-step assistance in passing the oncoming vehicle Ao (see FIG. 5 and the like) on a narrow road from before passing the oncoming vehicle Ao to after passing the oncoming vehicle Ao by displaying information on the meter display 21 and the HUD 23. The display related to the narrow road traveling assistance will be described in detail with reference to FIGS. 1 and 2 based on FIGS. 3 to 22. Instead of the meter display 21 or together with the meter display 21, the CID 22 may perform a screen display related to the narrow road traveling assistance.

The presentation control unit 77 switches the display mode of the HMI system 10 from the normal mode to the narrow road mode based on the state where the external environment information grasping unit 72 has grasped that the subject vehicle Am is entering the narrow road. The presentation control unit 77 continues the narrow road mode until the subject vehicle Am exits the narrow road. The presentation control unit 77 switches the display mode from the narrow road mode to the normal mode based on the result that the external environment information grasping unit 72 has grasped the exit of the subject vehicle Am from the narrow road.

### Display Transition (Screen Display) at Switching of Display Modes

The display in the normal mode shown in FIG. 3 (hereinafter, normal mode display MDN) is, for example, a screen display of the meter display 21 when the subject vehicle Am is traveling on a main road or the like. The normal mode display MDN includes a digital speedometer SM, a road background ImB, a subject vehicle icon ImA, and a different vehicle icon ImC. The digital speedometer SM indicates the current traveling speed of the subject vehicle Am as a numerical value based on vehicle speed information. The digital speedometer SM continues to display even when the display mode is changed.

The road background ImB displays the shape of the road on which the vehicle is traveling, the number of lanes, and the like, based on map data and the like. The subject vehicle icon ImA is an icon that imitates the external appearance of the subject vehicle Am, and notifies the driver of the state of the subject vehicle Am. The vehicle icon ImA is displayed approximately in the center of the road background ImB, at a location that corresponds to the subject vehicle lane on the road background ImB. The different vehicle icon ImC is an icon indicating a different vehicle (a parallelly traveling vehicle) that travels in the same direction as the subject vehicle Am. The different vehicle icon ImC is placed around the subject vehicle icon ImA so that the actual positional relationship between the subject vehicle Am and the different vehicle is reproduced on the display based on the relative position information of the different vehicle.

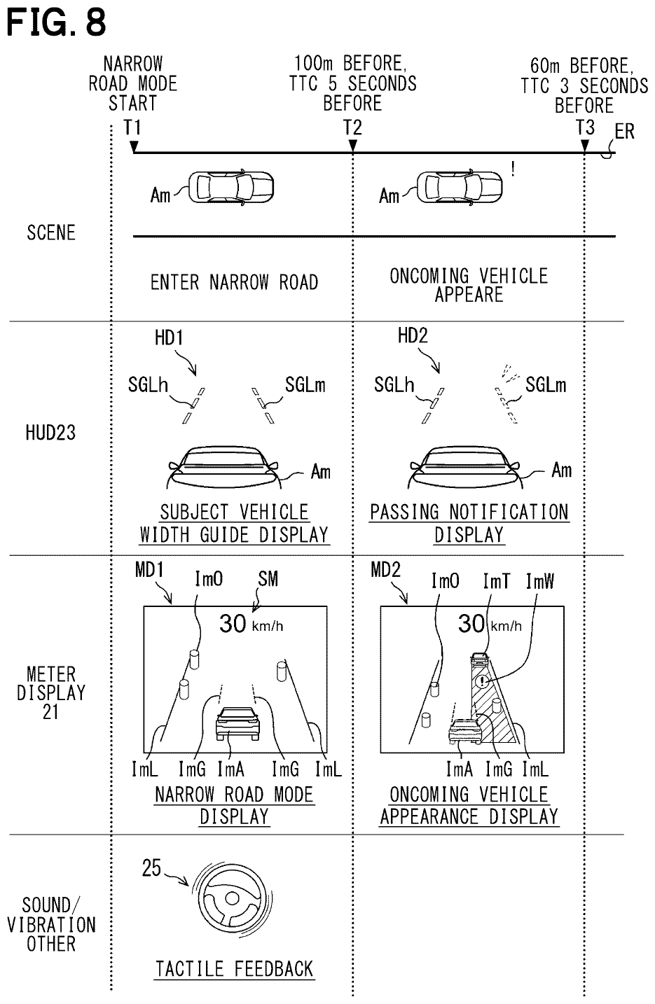

When the mode is switched from the normal mode to the narrow road mode, the presentation control unit 77 transitions the screen display of the meter display 21 from the normal mode display MDN to the narrow road mode display MD1 (see FIG. 8). At this time, the presentation control unit 77 sandwiches a transition display MDT between the normal mode display MDN and the narrow road mode display MD1. In the transition display MDT, the different vehicle icon ImC is hidden, and the road background ImB is changed to a pair of lane marking line icons ImL. Then, the viewpoint position of the bird's-eye view display consisting of the subject vehicle icon ImA and the pair of lane marking line icons ImL moves upward with the subject vehicle icon ImA at the center and approaches the subject vehicle icon ImA. After completing the zoom on the subject vehicle icon ImA, the presentation control unit 77 starts drawing an obstacle icon ImO indicating an obstacle around the subject vehicle Am and a subject vehicle width icon ImG indicating the vehicle width of the subject vehicle Am (see FIG. 8). With the above, the transition from the normal mode display MDN to the narrow road mode display MD1 via the transition display MDT is completed. In addition, when switching from the narrow road mode display MD1 to the normal mode display MDN, the transition display MDT is implemented in which the viewpoint position of the bird's-eye view display is moved downward while moving away from the subject vehicle icon ImA, which is the opposite of the transition described above.

### Display Transition at Switching of Display Modes (Virtual Image Display)

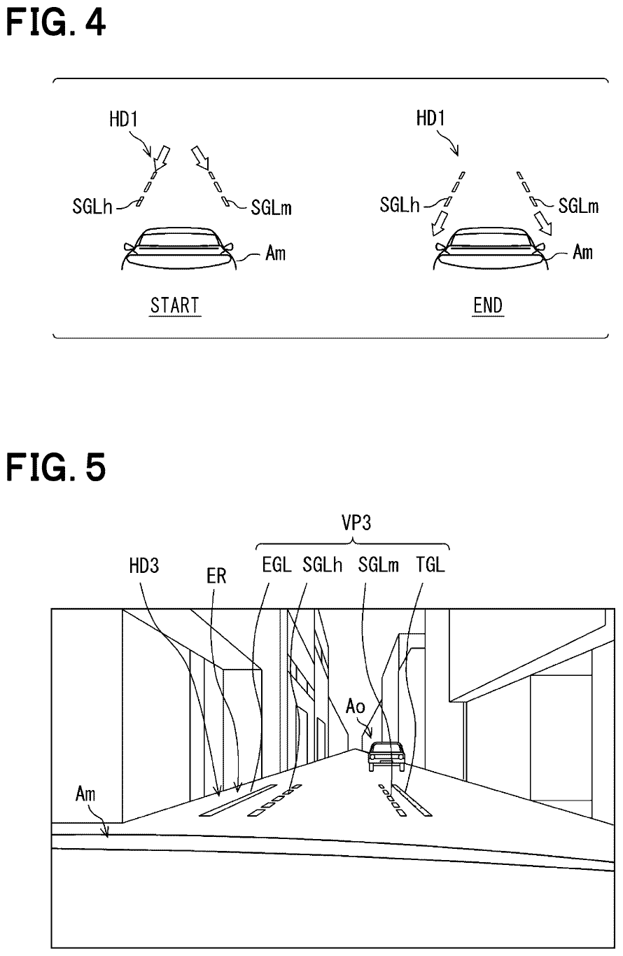

The subject vehicle width guide display HD1 shown in FIG. 4 is a virtual image display indicating the traveling on the narrow road in the narrow road mode that is started based on the entering of the narrow road. The subject vehicle width guide indication HD1 includes a pair of subject vehicle width guide lines SGLh, SGLm. The subject vehicle width guide lines SGLh, SGLm are drawn as dashed lines. The subject vehicle width guide lines SGLh, SGLm are overlapping contents that indicate the vehicle width of the subject vehicle Am, in other words, the position of the outer edge in the width direction of the subject vehicle Am. The left subject vehicle width guide line SGLh is displayed so as to overlap with the road surface ahead, and the line is on an extension of the left outer edge of the body of the subject vehicle Am. The right subject vehicle width guide line SGLm is displayed so as to overlap with the road surface ahead, and the line is on an extension of the right outer edge of the body of the subject vehicle Am. The subject vehicle width guide lines SGLh, SGLm indicate the future position of the subject vehicle Am.

When the subject vehicle width guide display HD1 starts (see the left part in FIG. 4) accompanying the start of the narrow road mode, the presentation control unit 77 causes the subject vehicle width guide lines SGLh, SGLm to fade into the field of view by moving them downward. As a result, the subject vehicle width guide lines SGLh, SGLm appear to the driver as approaching the subject vehicle Am from the front and positioned on the road surface ahead.

On the other hand, when the subject vehicle width guide display HD1 ends with the end of the narrow road mode (see the right part in FIG. 4), the presentation control unit 77 causes the subject vehicle width guide lines SGLh, SGLm to fade out by moving them downward outside the angle of view. As a result, the subject vehicle width guide lines SGLh, SGLm appear to the driver as they move backward of the subject vehicle Am and go out of the frame.

### Lateral Position Adjustment Assistance Display (Overlapping Display)

The overlapping guide display HD3 shown in FIG. 5 is a virtual image display that assists the lateral position adjustment of the subject vehicle Am by the driver. In the overlapping guide display HD3, a lateral position adjustment assistance overlapping image VP3 overlaps with the road surface ahead of the subject vehicle. The lateral position adjustment assistance overlapping image VP3 includes a pair of subject vehicle width guide lines SGLh, SGLm similar to the subject vehicle width guide display HD1 (see FIG. 4), as well as the road edge guide line EGL and the oncoming vehicle guide line TGL.

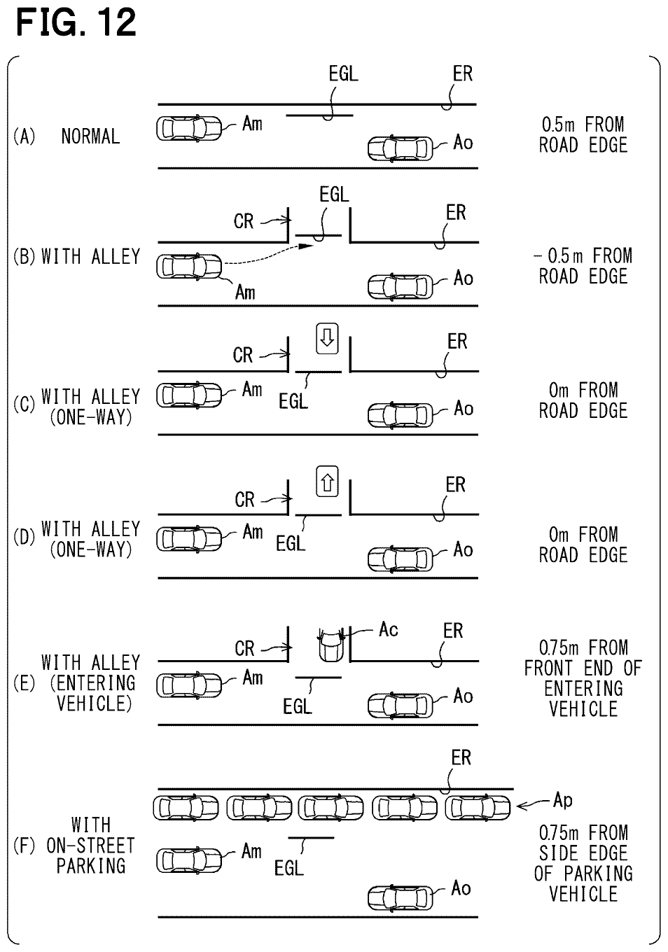

The road edge guide line EGL is an overlapping content that emphasizes the road edge ER close to the outer position (close to the left) of the narrow road. The road edge guide line EGL overlaps with the position of the road edge ER of the narrow road or on a position inside the narrow road edge ER based on the detection information of the road edge ER grasped by the external environment information grasping unit 72 (see FIG. 12).

The oncoming vehicle guide line TGL is an overlapping content that clearly indicates the position of the oncoming vehicle Ao that has appeared on the narrow road. The oncoming vehicle guide line TGL overlaps with the road surface ahead based on the detection information of the oncoming vehicle Ao grasped by the external environment information grasping unit 72, and the line is on an extension of the outer edge at the inner side (the right side) of the oncoming vehicle Ao toward the subject vehicle.

The driver can accurately move the subject vehicle Am close to the road edge ER by performing a steering operation to position the subject vehicle width guide lines SGLh, SGLm between the road edge guide line EGL and the oncoming vehicle guide line TGL. Specifically, the driver moves the subject vehicle Am so that the left subject vehicle width guide line SGLh approaches the road edge guide line EGL while the right subject vehicle width guide line SGLm moves as far to the left as possible of the oncoming vehicle guide line TGL. As a result, the subject vehicle Am is able to smoothly pass the oncoming vehicle Ao.

### Lateral Position Adjustment Assistance Display (Non-overlapping Display)

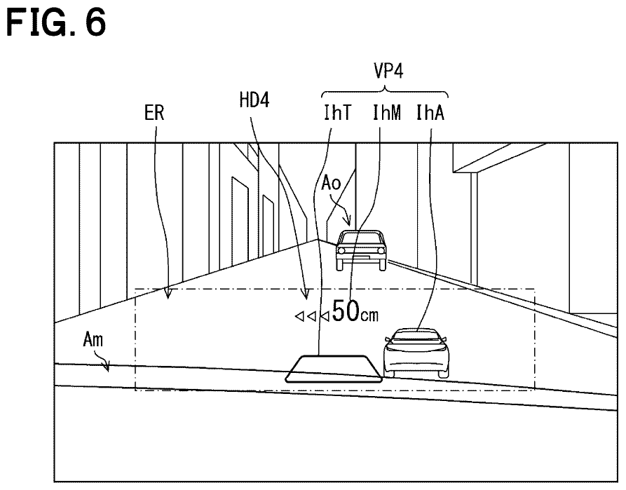

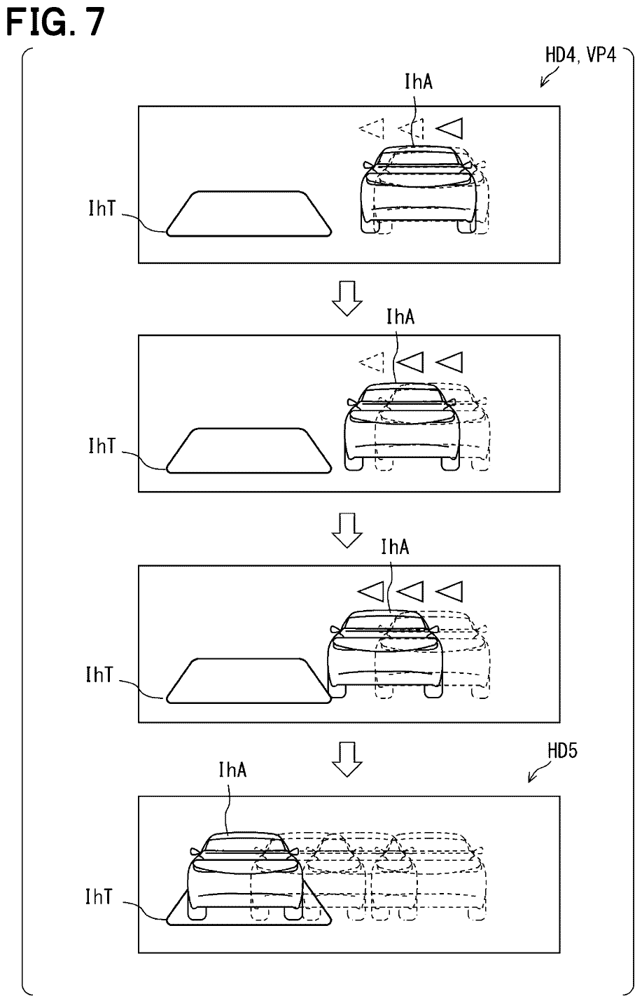

A non-overlapping guide display HD4 shown in FIGS. 6 and 7 is a virtual image display that assists the lateral position adjustment of the subject vehicle Am by the driver, similar to the overlapping guide display HD3 (see FIG. 5). In the non-overlapping guide display HD4, the HUD 23 displays a lateral position adjustment assistance icon image VP4 as the non-overlapping content. The lateral position adjustment assistance icon image VP4 includes a subject vehicle icon IhA, a movement target frame IhT, and a remaining distance meter IhM.

The subject vehicle icon IhA, like the subject vehicle icon ImA (see FIG. 3) displayed on the screen, is an icon that imitates the external appearance of the subject vehicle Am, and notifies the user of the state of the subject vehicle Am. The movement target frame IhT is a frame-shaped image portion placed at the side area with respect to the subject vehicle icon IhA. The movement target frame IhT is placed in the moving direction for the lateral position adjustment with respect to the subject vehicle icon IhA. The remaining distance meter IhM is displayed, for example, above the movement target frame IhT. The remaining distance meter IhM is an image portion that indicates, in numerical value form, the amount of movement in the width direction required to pass the oncoming vehicle Ao as a distance to be avoided.

The driver can move the subject vehicle Am to the road edge ER with high accuracy by performing a steering operation to position the subject vehicle icon IhA within the movement target frame IhT (see FIG. 7). Specifically, the driver moves the subject vehicle Am until the subject vehicle icon IhA is positioned in the center of the movement target frame IhT and the value on the remaining distance meter IhM reaches zero. The movement target frame IhT notifies the driver of completion of the lateral position adjustment by illuminating the inside of the frame in blue, for example. As a result, the subject vehicle Am is able to smoothly pass the oncoming vehicle Ao.

### Series of Display Transitions during Narrow Road Traveling Assistance

Next, a series of display transitions that assists passing on narrow roads using the subject vehicle width guide display HD1, the overlapping guide display HD3, the non-overlapping guide display HD4, and the like described so far will be described in detail with reference to FIGS. 8 to 11.

### Scene 1. Entering Narrow Road

The presentation control unit 77 causes the HUD 23 and the meter display 21 to display the subject vehicle width guide display HD1 and the narrow road mode display MD1 at the timing when the narrow road mode is started (hereinafter, timing T1) (see the left column in FIG. 8). The subject vehicle width guide display HD1 indicates the positions of both the left and right edges of the subject vehicle Am on the road surface ahead by the overlapping display of the subject vehicle width guide lines SGLh, SGLm (see also FIG. 4).

The narrow road mode display MD1 includes an obstacle icon ImO and a pair of subject vehicle width icons ImG in addition to the digital speedometer SM, the pair of lane line icons ImL, and the vehicle icon ImA. The obstacle icon ImO is an icon that indicates an obstacle that exists in a narrow road. The obstacle icons ImO are arranged around the subject vehicle icon ImA so that the actual positional relationship between the subject vehicle Am and the obstacle is reproduced on the display based on the relative position information of the obstacle. The subject vehicle width icon ImG is disposed above the subject vehicle icon ImA. The subject vehicle width icon ImG, combined with the lane marking line icon ImL and the obstacle icon ImO, indicates to the driver that there is sufficient widthwise clearance between the subject vehicle Am and the obstacle or road edge ER.

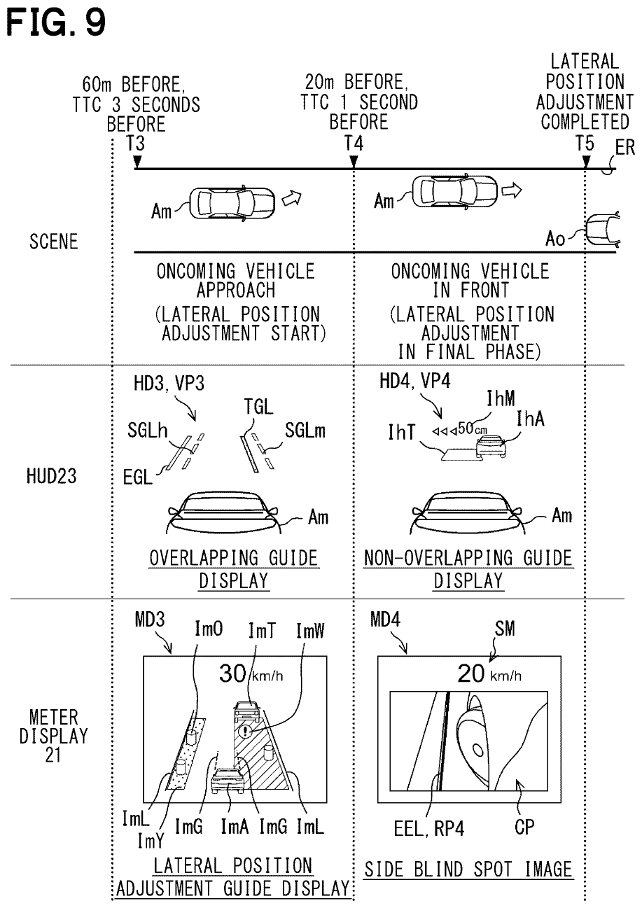

The subject vehicle width guide display HD1 and narrow road mode display MD1 clearly show the driver where the left and right outer edges of the subject vehicle Am are located on the narrow road by the subject vehicle width guide lines SGLh, SGLm and the subject vehicle width icon ImG. By such a display, the traveling position of the subject vehicle Am is guided to an appropriate position so that it is ready for the oncoming vehicle Ao (see FIG. 9) to appear at any time. As a result, a situation in which the subject vehicle Am travels excessively close to the center of the narrow road is avoided.

In addition, when the subject vehicle width icon ImG comes into contact with the lane line icon ImL or the obstacle icon ImO, vibration feedback is implemented by operating the tactile feedback device 25. Therefore, even when the driver is not paying attention to the narrow road mode display MD1 (meter display 21), the driver can recognize excess approach in the outward direction of the narrow road, and can appropriately correct the traveling position of the subject vehicle Am.

Furthermore, the driver state grasping unit 73 determines whether the driver's line of sight is directed toward the angle of view of the HUD 23 (the road surface ahead) at each of timings T1 to T7 when the presentation control unit 77 switches the display. When the driver's line of sight is outside the angle of view of the HUD 23, the presentation control unit 77 causes the audio device 24 to play a soft notification sound in synchronization with the timing of switching the display. As a result, the driver can get a sense of the approach of the oncoming vehicle Ao and can easily notice updates to the displayed information.

### Scene 2. Oncoming Vehicle

The external environment information grasping unit 72 grasps the appearance of the oncoming vehicle Ao that needs to be avoided based on detection information from the front camera unit 31, the millimeter wave radar 32, or the like. When the external environment information grasping unit 72 detects the oncoming vehicle Ao, it determines the timing when the distance from the subject vehicle Am to the oncoming vehicle Ao becomes approximately 100 meters or the timing when TTC (Time-To-Collision) becomes approximately 5 seconds (hereinafter referred to as timing T2). The TTC is the time it takes for the distance from the subject vehicle Am to the oncoming vehicle Ao to become zero.

The presentation control unit 77 switches the displays of the HUD 23 and the meter display 21 based on the determination by the external environment information grasping unit 72 that a timing T2 has arrived (see the right column in FIG. 8). The presentation control unit 77 switches the display on the HUD 23 from the subject vehicle width guide display HD1 to the passing notification display HD2. The presentation control unit 77 switches the display on the meter display 21 from the narrow road mode display MD1 to the oncoming vehicle appearance display MD2.

The passing notification display HD2 is an overlapping content that is displayed based on the recognition of the oncoming vehicle Ao, and notifies the driver of the appearance of the oncoming vehicle Ao. The passing notification display HD2 is a display that displays less information than the overlapping guide display HD3 (the lateral position adjustment assistance overlapping image VP3). In the passing notification display HD2, the subject vehicle width guide line SGLm in the inward direction closer to the oncoming vehicle Ao (close to the right of the oncoming vehicle Ao) is displayed in a flashing manner.

In the oncoming vehicle appearance display MD2, an oncoming vehicle icon ImT and an oncoming vehicle warning ImW are displayed in addition to the subject vehicle icon ImA, subject vehicle width icon ImG, lane line icon ImL, and obstacle icon ImO. The oncoming vehicle icon ImT is an icon that imitates the external shape of the oncoming vehicle Ao. The oncoming vehicle warning ImW includes an icon containing an exclamation mark and a strip-shaped image portion extending along the lane marking icon ImL. The oncoming vehicle warning ImW is drawn in a color that indicates a call for attention, such as yellow. The oncoming vehicle warning ImW is displayed in a state where it partially overlaps with the subject vehicle icon ImA and the subject vehicle width icon ImG close to the oncoming vehicle (the right of the oncoming vehicle).

The passing notification display HD2 and the oncoming vehicle appearance display MD2 notify the driver of the appearance of the oncoming vehicle Ao that requires the driver to perform the lateral position adjustment that moves the vehicle outward (to the left). The amount of information presented in the passing notification display HD2 and the oncoming vehicle presence display MD2 is limited, and only the necessity of avoidance is notified. In other words, the passing notification display HD2 and the oncoming vehicle appearance display MD2 do not convey the degree of avoidance required, the amount of movement, and the like. The passing notification display HD2 and the oncoming vehicle appearance display MD2 subtly alert the driver to the risk of the oncoming vehicle Ao and prompt the driver to take early preparation action.

### Scene 3. Oncoming Vehicle Approaching

The external environment information grasping unit 72 determines the timing when the distance from the subject vehicle Am to the oncoming vehicle Ao becomes approximately 60 meters or the TTC becomes approximately 3 seconds (hereinafter, timing T3) based on detection information from the front camera unit 31 or the millimeter wave radar 32, and the like. The presentation control unit 77 switches the displays of the HUD 23 and the meter display 21 based on the determination by the external environment information grasping unit 72 that a timing T3 has arrived (see the left column in FIG. 9). The presentation control unit 77 switches the display of the HUD 23 from the passing notification display HD2 to the overlapping guide display HD3 (see also FIG. 5). The presentation control unit 77 switches the display on the meter display 21 from the oncoming vehicle presence display MD2 to a lateral position adjustment guide display MD3.

The overlapping guide display HD3 is a display that assists the lateral position adjustment toward the outside of the narrow road when the oncoming vehicle Ao is detected by the overlapping display of the above-described assistance overlapping image VP3 on the road surface in front of the subject vehicle. The lateral position adjustment assistance overlapping image VP3 includes at least the subject vehicle width guide lines SGLh, SGLm, the road edge guide lines EGL, and the oncoming vehicle guide lines TGL.

In the lateral position adjustment guide display MD3, in addition to the subject vehicle icon ImA, subject vehicle width icon ImG, lane line icon ImL, obstacle icon ImO, oncoming vehicle icon ImT, and oncoming vehicle warning ImW, a lateral position adjustment guide image ImY is additionally displayed. The lateral position adjustment guide image ImY is a strip-shaped image portion extending along the lane marking line icon ImL outward (to the left) of the subject vehicle icon ImA. The lateral position adjustment guide image ImY is displayed overlapping with the obstacle icon ImO. The lateral position adjustment guide image ImY is drawn in a color different from that of the oncoming vehicle warning ImW and in the same or similar color (for example, green) as the subject vehicle width guide line SGLh.

The overlapping guide display HD3 and the lateral position adjustment guide display MD3 additionally display information about the vicinity of the subject vehicle in accordance with the approach of the oncoming vehicle Ao. Specifically, the position of the road edge ER and the predicted passing position of the oncoming vehicle Ao are presented on the overlapping guide display HD3 and the lateral position adjustment guide display MD3. Such a display allows the driver to grasp an indication of how far the obstacle can be avoided and how far the obstacle should be avoided. As a result, the driver can smoothly start the initial movement of the lateral position adjustment toward the outside and move the subject vehicle Am to the left at an earlier stage.

### Scene 4. Right before Oncoming Vehicle

The external environment information grasping unit 72 determines the timing when the distance from the subject vehicle Am to the oncoming vehicle Ao becomes approximately 20 meters or the TTC becomes approximately 1 second (hereinafter, timing T4) based on detection information from the front camera unit 31 or the millimeter wave radar 32, and the like. The external environment information grasping unit 72 may determine the timing T4 based on detection information from the surround camera system 33, the sonar 34, or the like. Furthermore, the external environment information grasping unit 72 may determine the timing T4 based on a decrease in the speed of the subject vehicle Am (for example, the traveling speed is 20 km/h or less).

The presentation control unit 77 switches the displays of the HUD 23 and the meter display 21 based on the determination by the external environment information grasping unit 72 that the timing T4 has arrived (see the right column in FIG. 9). The presentation control unit 77 switches the display of the HUD 23 from the overlapping guide display HD3 to the non-overlapping guide display HD4 (see also FIGS. 6 and 7). The presentation control unit 77 switches the display on the meter display 21 from the lateral position adjustment guide display MD3 to the side blind spot image MD4.

The non-overlapping guide display HD4 is a display including the above-described lateral position adjustment assistance icon image VP4. The lateral position adjustment assistance icon image VP4 is a non-overlapping content displayed in place of the lateral position adjustment overlapping image VP3, and provides assistance for moving over and passing by using the subject vehicle icon IhA indicating the subject vehicle Am.

The side blind spot image MD4 is an outside image obtained by overlapping the passing assistance image RP4 that assists passing the oncoming vehicle Ao on a camera image CP when passing the oncoming vehicle Ao. The camera image CP is an image captured by the left side camera. The camera image CP captures the left side road surface including the road edge ER among the road surfaces in the periphery of the subject vehicle Am. The camera image CP further captures the vicinity of the left front wheel of the subject vehicle Am.

The passing assistance image RP4 is an image that includes at least the road edge highlighting line EEL. The road edge highlighting line EEL overlaps with the road edge ER captured in the camera image CP. The road edge highlighting line EEL indicates the position of the road edge ER which is the target to which the left front wheel is to be approached. The road edge highlighting line EEL is drawn in the same or similar color (for example, green) as the lateral position adjustment guide image ImY and the road edge guide line EGL, and highlight the road edge ER in the camera image CP. The passing assistance image RP4 highlights the road edge ER with the road edge highlighting line EEL, thereby providing the assistance of the lateral position adjustment to the road edge ER and thereby providing the assistance of passing the oncoming vehicle Ao.

The non-overlapping guide display HD4 and side blind spot image MD4 described above can accurately and specifically (numerically) show the driver the remaining amount of avoidance at the end of the lateral position adjustment by using the remaining distance meter IhM and the camera image CP. Therefore, the driver can smoothly perform the lateral position adjustment to the road edge ER with high accuracy.

Here, the display before the timing T4 is a display for generating a state where the vehicles can pass each other smoothly at an earlier stage. During this period, the subject vehicle Am is still moving at a high speed. Therefore, in order to keep the line of sight of the driver fixed on the front and to make it easier for the driver to grasp the overall position rather than the details, emphasis is placed on assistance provided by the virtual image display of the HUD 23.

On the other hand, the display from the timing T4 onwards shows a scene in which the vehicle passes the oncoming vehicle Ao at a low speed. Therefore, the driver may be permitted to perform driving allowing the line of sight of the driver to be deviated from the front at the driver pace. Therefore, detailed information for confirming that there will be no contact with the oncoming vehicle Ao is presented on a screen such as the meter display 21. That is, in the display after the timing T4, emphasis is placed on prompting the driver to understand how far the vehicle can move, how far the vehicle should move, and whether the vehicle has moved properly.

### Scene 5. Completion of Lateral Position Adjustment

The external environment information grasping unit 72 determines the timing (hereinafter, timing T5) at which the subject vehicle Am completes the lateral position adjustment. The external environment information grasping unit 72 determines that the timing T5 is the timing when the traveling speed of the subject vehicle Am becomes equal to or lower than a predetermined speed (for example, 10 km/h) or the timing when the steering angle returns to approximately 0 degrees. Based on the positional relationship between the outer edge of the vehicle Am in the outward direction (at the left to the subject vehicle Am) and the road edge ER, the external environment information grasping unit 72 may determine that the timing T5 is a timing when the outer edge of the subject vehicle Am comes sufficiently close to the road edge ER and is generally parallel to the road edge ER. Furthermore, based on the positional relationship between the inner outer edges of the subject vehicle Am and the oncoming vehicle Ao, the external environment information grasping unit 72 may determine that the timing T5 is the timing when a clearance in the width direction is secured, and, in the inward direction, the outer edges of the subject vehicle Am and the oncoming vehicle Ao are approximately parallel to each other.

The presentation control unit 77 switches the displays of the HUD 23 and the meter display 21 based on the determination by the external environment information grasping unit 72 that the timing T5 has arrived (see the left column in FIG. 10). The presentation control unit 77 switches the display on the HUD 23 from the non-overlapping guide display HD4 to the lateral position adjustment completion notification display HD5 (see also the bottom row of FIG. 7). The presentation control unit 77 switches the display on the meter display 21 from the side blind spot image MD4 to the rear image MD5.

The lateral position adjustment completion notification display HD5 is a display including the subject vehicle icon IhA and the movement target frame IhT. The lateral position adjustment completion notification display HD5 indicates that the remaining movement distance required for passing has reached zero by changing the color of the movement target frame IhT.

The rear image MD5 is an external image obtained by overlapping a trajectory image RP5 with a camera image CP. The camera image CP is an image captured by a rear camera, and is an image showing the area behind the subject vehicle Am. The camera image CP captures the road surface behind the subject vehicle Am among the road surfaces in the periphery of the subject vehicle Am. The trajectory image RP5 is a band-shaped image portion that indicates the movement trajectory (traveling trajectory) of the subject vehicle Am. The trajectory image RP5 is drawn in a display color such as light red. The trajectory image RP5 makes it easy to confirm whether the subject vehicle Am is parallel to the road edge ER.

The above-described lateral position adjustment completion notification display HD5 and rear image MD5 are displayed when the subject vehicle Am is in a position where it can pass the oncoming vehicle Ao, and notify the driver that the lateral position adjustment has been completed. As a result, the driver can be confident that the driver has been able to avoid the oncoming vehicle Ao by an amount sufficient to pass it, without worrying about whether there is still a need to avoid the oncoming vehicle Ao. Thereby, it is possible to prevent excessive lateral position adjustment.

In addition, the presentation control unit 77 performs vibration feedback by operating the tactile feedback device 25 based on the determination, by the external environment information grasping unit 72, that the timing T5 has arrived. This vibration feedback, like the lateral position adjustment completion notification display HD5 and the rear image MD5, can inform the driver that the driver has been able to perform the lateral position adjustment that moves the subject vehicle to a position where the oncoming vehicle Ao can be sufficiently avoided.

### Scene 6. Start of Passing

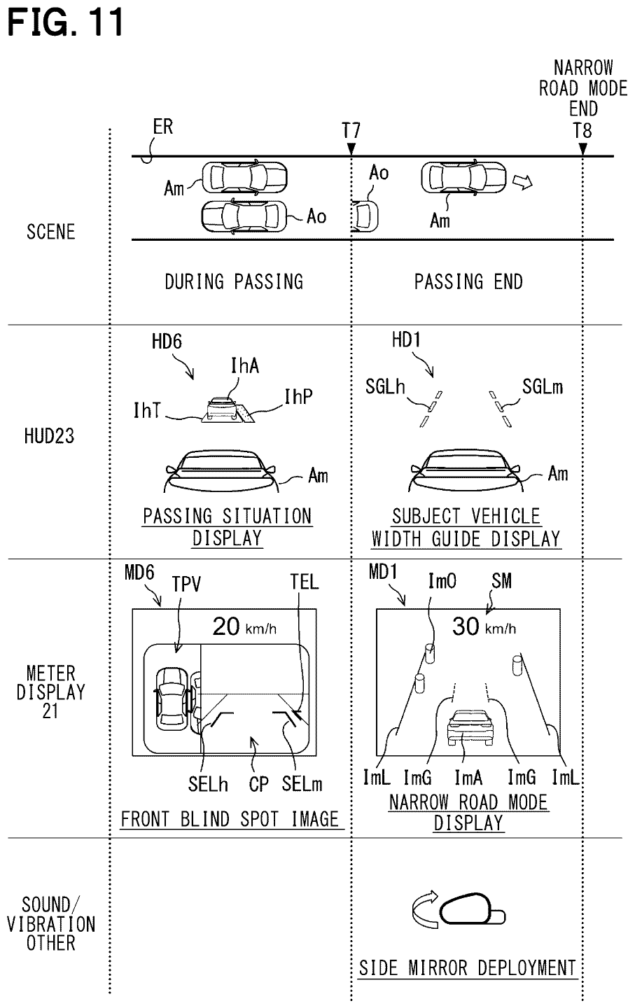

The external environment information grasping unit 72 determines a timing when the distance from the subject vehicle Am to the oncoming vehicle Ao becomes 0 meters, in other words, the timing when the TTC becomes 0 seconds (hereinafter, timing T6), based on detection information from the surround camera system 33 or the sonar 34, and the like. The presentation control unit 77 switches the displays of the HUD 23 and the meter display 21 based on the determination by the external environment information grasping unit 72 that the timing T6 has arrived (see the right column in FIG. 10 and the left column in FIG. 11). The presentation control unit 77 switches the display on the HUD 23 from the lateral position adjustment completion notification display HD5 to a passing situation display HD6. The presentation control unit 77 switches the display on the meter display 21 from the rear image MD5 to the front blind spot image MD6.

In addition to the subject vehicle icon IhA and the movement target frame IhT, a passing progress bar IhP is additionally displayed on the passing situation display HD6. The passing progress bar IhP is drawn based on the relative position information of the oncoming vehicle Ao grasped by the external environment information grasping unit 72. The passing progress bar IhP extends downward along the movement target frame IhT as the passing with the oncoming vehicle Ao progresses (see the left column in FIG. 11). The passing progress bar IhP continuously indicates to the driver the positional relationship between the subject vehicle Am and the oncoming vehicle Ao.

The front blind spot image MD6 is an external image that includes the above-described top-view image TPV and the camera image CP captured by the front camera of the surround camera system 33. The camera image CP captures the road surface in front of the subject vehicle Am, which is within the driver blind spot, among the road surfaces around the subject vehicle Am. Subject vehicle width highlighting lines SELh, SELm and an oncoming vehicle highlighting lines TEL overlap with the camera image CP.

The subject vehicle width highlighting lines SELh, SELm are L-shaped line images that indicate the position of the outer edge in the width direction of the subject vehicle Am (vehicle width) and the position of the front end of the subject vehicle Am. The subject vehicle width highlighting lines SELh, SELm are drawn in a color different from that of the oncoming vehicle highlighting lines TEL, and in the same color as or similar color to (for example, green) the road edge highlighting lines EEL and the lateral position adjustment guide image ImY.

The oncoming vehicle highlighting line TEL is an L-shaped line image drawn in a warning color such as red. Immediately after starting to pass each other, the oncoming vehicle highlighting line TEL is displayed, which indicates the position of the outer edge close to the subject vehicle (in the inward direction) and front end of the oncoming vehicle Ao (see the right column in FIG. 10). Furthermore, immediately before the end of the passing, the oncoming vehicle highlighting line TEL is displayed, and indicates the position of the outer edge close to the subject vehicle (inward direction) and the rear end of the oncoming vehicle Ao (see the left column in FIG. 11).

The passing situation display HD6 and the front blind spot image MD6 described above can alleviate the anxiety of the driver about coming into contact with the oncoming vehicle Ao by showing the passing situation of the oncoming vehicle Ao. Furthermore, the front blind spot image MD6 shows an image of the outside environment in the blind spot area in front of the subject vehicle Am, and thereby it is indicated that a sufficient distance is maintained between the oncoming vehicle Ao and the subject vehicle Am. Thereby, it is possible to further reduce the driver's anxiety about contact.

In addition, the instruction output unit 75 determines whether the side mirror needs to be folded up between the time T5 when the subject vehicle Am is in a position to pass the oncoming vehicle Ao and the time T6 when the subject vehicle Am starts to pass the oncoming vehicle Ao. When the space that can be secured when passing the oncoming vehicle Ao is small, the instruction output unit 75 determines that the side mirrors need to be folded up. In this case, the instruction output unit 75 cooperates with the body ECU 43 and the mirror folding mechanism 44 to start the folding operation to automatically fold the side mirrors at the timing T6 when the front end of the oncoming vehicle Ao reaches the front end of the subject vehicle Am. The instruction output unit 75 may fold both side mirrors, or may fold only the side mirror close to the oncoming vehicle side (the right side mirror). Furthermore, in a scene where there is an obstacle such as a utility pole at the outward position (at the left) on the narrow road, the instruction output unit 75 may fold only the side mirror close to the outward position on the narrow road. When the side mirrors are folded, the presentation control unit 77 reflects the folding of the door mirrors in the subject vehicle image in the top-view image TPV. The timing at which the door mirrors start to fold may be changed as appropriate as long as it is after the timing T5 and before the oncoming vehicle Ao reaches the position of the door mirrors of the subject vehicle Am.

### Scene 7. After End of Passing

The external environment information grasping unit 72 determines the timing (hereinafter, timing T7) at which the rear end of the oncoming vehicle Ao passes the rear end of the subject vehicle Am based on detection information from the surround camera system 33, the sonar 34, or the like. Based on the determination by the external environment information grasping unit 72 that the timing T7 has arrived, the presentation control unit 77 switches the displays of the HUD 23 and the meter display 21 to the subject vehicle width guide display HD1 and the narrow road mode display MD1, respectively (see the right column of FIG. 11). Furthermore, when dry mirrors are stored, the instruction output unit 75 starts a deployment operation to open the side mirrors in cooperation with the body ECU 43 and the mirror folding (storage) mechanism 44 based on the determination that the timing T7 has arrived.

The presentation control unit 77 ends the narrow road mode at a timing (hereinafter, timing T8) when the external environment information grasping unit 72 determines that the vehicle is exiting the narrow road, and switches the display mode to the normal mode. The presentation control unit 77 ends the display by the HUD 23 based on the switching to the normal mode. Furthermore, the presentation control unit 77 transitions the display on the meter display 21 from the narrow road mode display MD1 to the normal mode display MDN (see FIG. 3).

### Overlapping Position Adjustment According to Road Edge Situation

The presentation control unit 77 changes the overlapping position of the road edge guide line EGL, which indicates the position of the road edge ER, on the lateral position adjustment overlapping image VP3 (see FIG. 5), depending on the situation of the road edge ER grasped by the external environment information grasping unit 72 (see FIG. 12). Normally, the presentation control unit 77 overlap the road edge guide line EGL at a position 0.5 m from the road edge ER recognized by the external environment information grasping unit 72 (see a part of (A) in FIG. 12).

On the other hand, when the alley CR that intersects with the narrow road is connected to the road edge ER, the presentation control unit 77 overlaps the road edge guide line EGL at a position 0.5 m behind the alley CR from the road edge ER (see a part of (B) in FIG. 12). In this case, the driver can pass the oncoming vehicle Ao while following the guidance of the road edge guide lines EGL and withdrawing at least a portion of the subject vehicle Am into the alley CR.

The external environment information grasping unit 72 grasps whether the alley CR connected to the road edge ER is a one-way alley CR based on map data or the like. In the case of one-war alley CR, the presentation control unit 77 overlaps the road edge guide line EGL at a position 0 m from the road edge ER, regardless of the traveling direction permitted for the alley CR (see parts of (C) and (D) in FIG. 12).

The external environment information grasping unit 72 grasps whether there is another vehicle (hereinafter, an entering vehicle Ac) that is about to enter the narrow road from the alley CR. When the approaching vehicle Ac is detected, the risk of the approaching vehicle Ac traveling out is taken into consideration. In this case, the presentation control unit 77 overlaps the road edge guide line EGL at a position 0.75 m from the front end of the entering vehicle Ac (see a part of (E) in FIG. 12).

The external environment information grasping unit 72 grasps a large number of other vehicles (hereinafter, parked vehicles Ap) parked on the narrow road. When there are many parked vehicles Ap, the risk of a pedestrian or the like running out between the parked vehicles Ap is taken into consideration. The presentation control unit 77 overlaps the road edge guide line EGL at a position 0.75 m from the side edge of the group of parked vehicles Ap lined up along the road edge ER (see a part of (F) in FIG. 12).

### Display Change Depending on Complexity of Road Edge

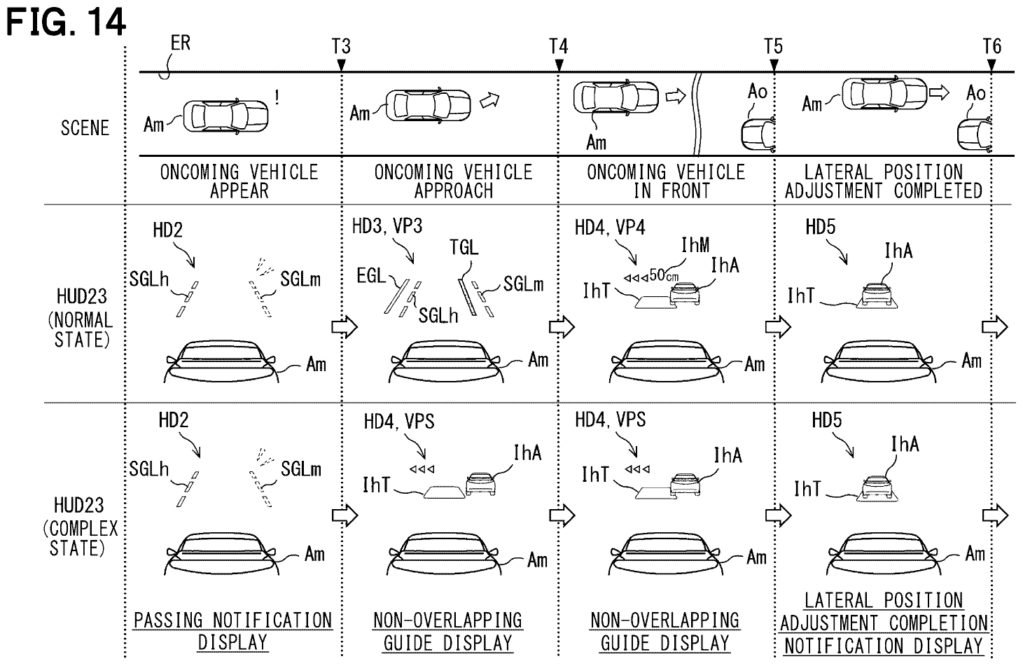

As described above, the external environment information grasping unit 72 grasps the situation of the road edge ER of the narrow road, and determines whether the road edge ER is in a complex situation depending on the number and type of obstacles present in the narrow road (see FIG. 13). When the road edge ER is in the complex situation, the presentation control unit 77 stops the overlapping display of the lateral position adjustment assistance overlapping image VP3. The presentation control unit 77 displays an alternative assistance image VPS using non-overlapping content instead of the lateral position adjustment assistance overlapping image VP3 using the overlapping content (see FIG. 14).

More specifically, when the road edge ER is not in the complex situation, the presentation control unit 77 performs the switching from the passing notification display HD2 to the overlapping guide display HD3 at the timing T3. Thereby, the HUD 23 displays the lateral position adjustment assistance overlapping image VP3. On the other hand, when the road edge ER is in the complex situation, at the timing T3, the presentation control unit 77 performs the switching from the passing notification display HD2 to the non-overlapping guide display HD4, and causes the HUD 23 to display the alternative assistance image VPS.

The alternative assistance image VPS includes the same subject vehicle icon IhA and movement target frame IhT as those in the lateral position adjustment assistance icon image VP4. On the other hand, in the alternative assistance image VPS, the remaining distance meter IhM is omitted. The non-overlapping guide display HD4 including the alternative assistance image VPS continues to be displayed until the timing T5 arrives, similar to the non-overlapping guide display HD4 in the normal state.

In the above-described situation where the road edge ER is in the complex situation, the position of the road edge ER recognized by the external environment information grasping unit 72 may frequently change. Therefore, when the road edge guide line EGL is displayed, the overlapping position of the road edge guide line EGL becomes unstable. Similarly, when the remaining distance meter IhM is displayed, the value indicating the remaining travel distance becomes unstable. In order to avoid such display fluctuation, the presentation control unit 77 omits the cancellation of the lateral position adjustment assistance overlapping image VP3, and displays, the from timing T3, the alternative assistance image VPS, which is the lateral position adjustment assistance icon image VP4 excluding the remaining distance meter IhM. As a result, it is possible to appropriately assist the lateral position adjustment of the driver at the timings T3 to T5 while preventing the used of the virtual image display from becoming difficult.

### Display Change Depending on Behavior of Oncoming Vehicle

When the external environment information grasping unit 72 grasps the oncoming vehicle Ao, it further grasps the behavior of the oncoming vehicle Ao. The external environment information grasping unit 72 determines whether the behavior of the oncoming vehicle Ao is unstable. When the oncoming vehicle Ao is swaying from side to side, or when the oncoming vehicle Ao is traveling at a position close to the center despite the absence of an obstacle, the external environment information grasping unit 72 determines that the behavior of the oncoming vehicle Ao is unstable.

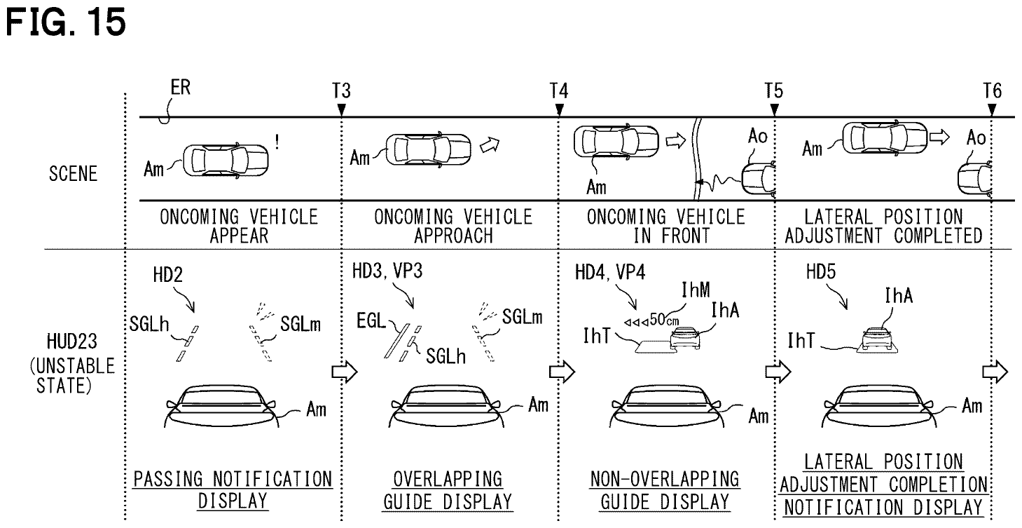

When the external environment information grasping unit 72 determines that the behavior of the oncoming vehicle Ao is unstable, the presentation control unit 77 omits display of the oncoming vehicle guide lines TGL (see FIG. 5) included in the lateral position adjustment assistance overlapping image VP3. Only the subject vehicle width guide lines SGLh, SGLm and the road edge guide lines EGL are displayed in the lateral position adjustment assistance overlapping image VP3 (see FIG. 15). The presentation control unit 77 continues to flash the subject vehicle width guide line SGLm even after the timing T4 to alert the driver of the approaching oncoming vehicle Ao.

In the above-described situation where the behavior of the oncoming vehicle Ao is unstable, when the oncoming vehicle guide lines TGL are displayed, the overlapping position of the oncoming vehicle guide lines TGL will become unstable. In order to avoid such unstable display, the presentation control unit 77 stops displaying the oncoming vehicle guide line TGL, and only guides the subject vehicle Am in the outward direction (to the leftward) on the narrow road. Based on the above, it is possible to appropriately assist the lateral position adjustment by the driver at the timings T3 to T5 while preventing the virtual image display from becoming difficult to use.

### Display Changes Depending on Speed of Oncoming Vehicle

When the external environment information grasping unit 72 grasps the oncoming vehicle Ao, it further grasps the traveling speed of the oncoming vehicle Ao. The external environment information grasping unit 72 grasps the relative speed of the oncoming vehicle Ao, and determines whether the relative speed is equal to or greater than a predetermined speed (hereinafter, the approach threshold). The external environment information grasping unit 72 may grasp the absolute speed of the oncoming vehicle Ao and determine whether the absolute speed is equal to or greater than a predetermined speed.

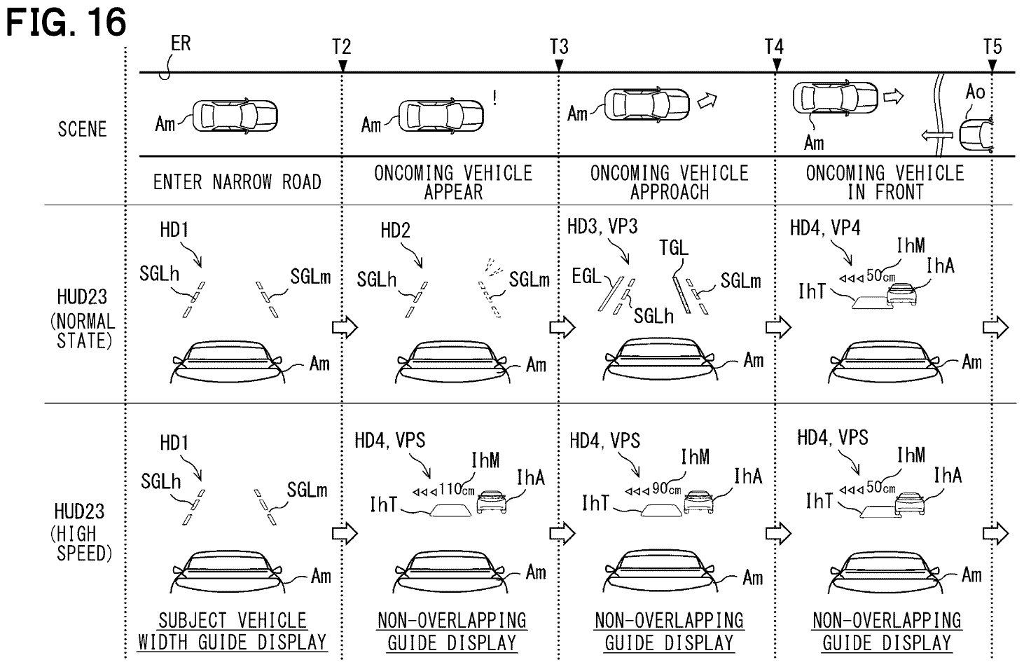

When the oncoming vehicle Ao approaches the subject vehicle Am at a relative speed exceeding the approach threshold, the presentation control unit 77 stops the overlapping display of the lateral position adjustment assistance overlapping image VP3. The presentation control unit 77 does not switch the display to the passing notification display HD2 at the timing T2, and does not switch the display to the overlapping guide display HD3 at the timing T3. The presentation control unit 77 starts the non-overlapping guide display HD4 using the alternative assistance image VPS at the timing T2, and continues displaying the non-overlapping guide display HD4 until the timing T5 (see FIG. 16). The alternative assistance image VPS is substantially the same image as the lateral position adjustment assistance icon image VP4, and includes the subject vehicle icon IhA, the movement target frame IhT, and the remaining distance meter IhM.

In the above-described situation where the oncoming vehicle Ao is approaching at high speed, the lateral position adjustment assistance overlapping image VP3 is switched to the lateral position adjustment assistance icon image VP4 in a very short time, and the driver may become annoyed by the display. Therefore, the presentation control unit 77 skips the overlapping guide display HD3 that provides assists for the initial stage of lateral position adjustment. Furthermore, the presentation control unit 77 advances the lateral position adjustment assistance using the non-overlapping guide display HD4, thereby urging the driver to complete the lateral position adjustment early.

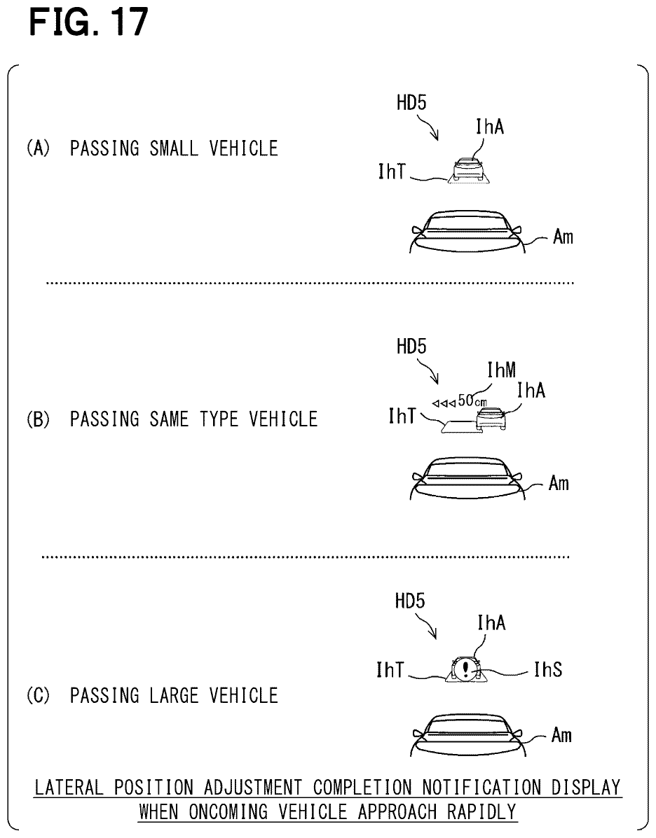

Furthermore, when the relative speed of the oncoming vehicle Ao is equal to or greater than the approach threshold, the external environment information grasping unit 72 grasps the size of the oncoming vehicle Ao. When the oncoming vehicle Ao approaches the subject vehicle Am at a speed exceeding the approach threshold, the presentation control unit 77 changes the content of the lateral position adjustment completion notification display HD5 according to the size of the oncoming vehicle Ao (see FIG. 17).

Specifically, when the oncoming vehicle Ao is a vehicle smaller than the subject vehicle Am (for example, a light vehicle), the presentation control unit 77 notifies the completion of the lateral position adjustment by changing the color of the movement target frame IhT as usual (see a part of (A) in FIG. 17). On the other hand, when the oncoming vehicle Ao is the same type of vehicle as the subject vehicle Am, the presentation control unit 77 provides assistance in further moving the vehicle closer by continuing to display the subject vehicle icon IhA, the movement target frame IhT, and the remaining distance meter IhM (see a part of (B) in FIG. 17).

Furthermore, when the oncoming vehicle Ao is a vehicle (for example, a truck or the like) larger than the subject vehicle Am, the presentation control unit 77 further displays a stop icon IhS (see a part of (C) in FIG. 17). The stop icon IhS is displayed and overlaps with the subject vehicle icon IhA displayed in the center of the movement target frame IhT. The stop icon IhS is an icon including an exclamation mark, and is drawn in a color that calls attention, such as yellow. The presentation control unit 77 prompts the driver to stop the subject vehicle Am by additionally displaying the stop icon IhS.

### Display Change in Case of Presence of Preceding Vehicle

The external environment information grasping unit 72 grasps the presence of a preceding vehicle when the vehicle is traveling on the narrow road. When the preceding vehicle is present, the external environment information grasping unit 72 grasps the size of the preceding vehicle and determines whether the preceding vehicle is larger than the subject vehicle Am. Furthermore, the external environment information grasping unit 72 grasps the distance from the subject vehicle Am to the preceding vehicle, and determines whether the distance is equal to or greater than a predetermined distance (hereinafter, the following threshold).

In a case where the preceding vehicle is a vehicle (for example, a truck) larger than the subject vehicle Am, when the preceding vehicle is able to pass, the subject vehicle Am should also be able to pass. Therefore, when the preceding vehicle is a large vehicle, the presentation control unit 77 reduces the assistance provided by the display on the HUD 23 compared to when there is no preceding vehicle. Specifically, the presentation control unit 77 stops displaying the subject vehicle width guide display HD1, the passing notification display HD2, and the overlapping guide display HD3.

Even in a case where the preceding vehicle is smaller than the subject vehicle Am (for example, a light vehicle), when the vehicle-to-vehicle distance to the preceding vehicle is short, the subject vehicle Am will often be able to pass the preceding vehicle. Therefore, the presentation control unit 77 similarly stops displaying the subject vehicle width guide display HD1, the passing notification display HD2, and the overlapping guide display HD3 when the vehicle-to-vehicle distance to the leading vehicle is less than the following threshold.

In the above-described scenes, the presentation control unit 77 can stop each display so that the driver's visibility of the preceding vehicle is not hindered by a virtual image. In addition, the presentation control unit 77 starts displaying the non-overlapping guide display HD4 from the timing T4 onward. In this way, the assistance is performed from the end of lateral position adjustment onwards. Thereby, the driver is possible to receive the assistance using the display at the passing.

### Cancelling Narrow Road Mode in Middle

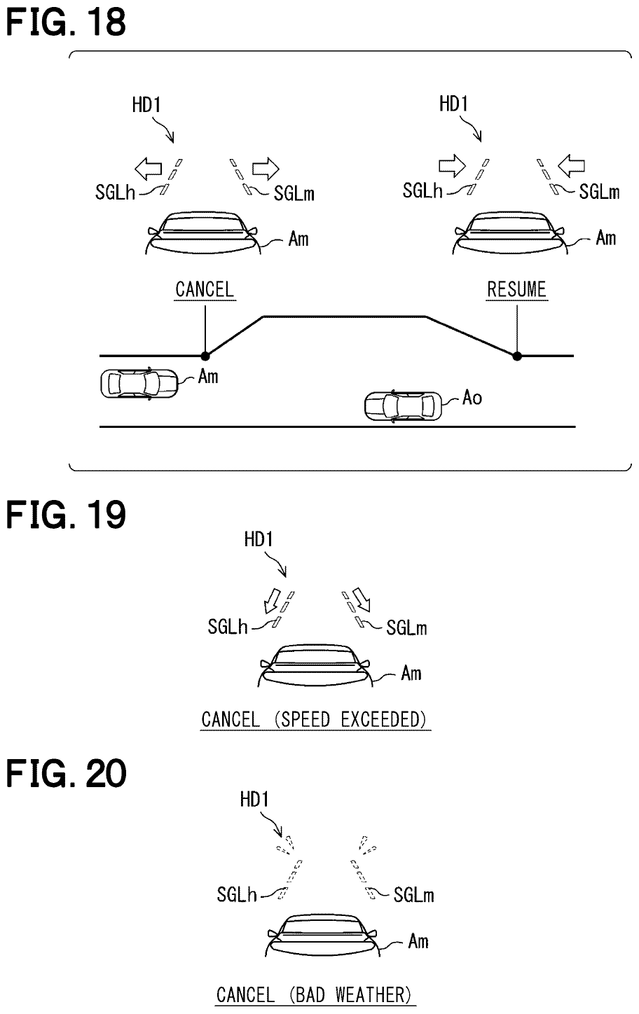

The external environment information grasping unit 72 grasps a temporary increase in the width of a narrow road (see FIG. 18). The presentation control unit 77 cancels the narrow road mode when a temporary increase in the width of a narrow road is detected. When the narrow road mode is cancelled, the presentation control unit 77 causes the HUD 23 to end the subject vehicle width guide display HD1. At this time, the presentation control unit 77 implements a display different from that when the narrow road mode ends (see the right part in FIG. 4). That is, the presentation control unit 77 changes the expression for removing the subject vehicle width guide display HD1 in an interruption scene where the road width of the narrow road temporarily widens and an end scene where the narrow road ends. Even when the narrow road mode is cancelled, the presentation control unit 77 causes the meter display 21 to continue displaying in the narrow road mode.

The presentation control unit 77 causes the subject vehicle width guide lines SGLh, SGLm of the subject vehicle width guide display HD1 to fade out to the outside on the left and right in accordance with the cancellation of the narrow road mode. As a result, the subject vehicle width guide display HD1 disappears as it spreads outward (see the left part in FIG. 18). Furthermore, the presentation control unit 77 causes the subject vehicle width guide lines SGLh, SGLm to fade in from the outside on the left and right in response to the resumption of the narrow road mode. As a result, the subject vehicle width guide display HD1 restarts with an animation that evokes the narrowing road width.

When the narrow road mode is cancelled for a reason other than the widening of the road width during traveling on the narrow road, the presentation control unit 77 changes the expression for erasing the subject vehicle width guide display HD1 according to the reason for the cancellation. As an example, the presentation control unit 77 cancels the narrow road mode when the speed of the subject vehicle Am traveling on the narrow road exceeds a predetermined upper speed limit. In this case, the presentation control unit 77 moves the subject vehicle width guide lines SGLh, SGLm rearward in a flowing manner and causes them to fade out of the angle of view (see FIG. 19). At this time, the presentation control unit 77 causes the dashed line patterns of the subject vehicle width guide lines SGLh, SGLm to flow in the opposite direction (upward) to the direction of movement to generate an animation that gives an unnatural feeling. Furthermore, the presentation control unit 77 causes the meter display 21 to display an icon that alerts the driver to speeding.

As another example, the presentation control unit 77 cancels the narrow road mode when it is difficult for the periphery monitoring sensor 30 to detect targets due to poor visibility caused by bad weather, in other words, when the reliability of the detection information cannot be ensured. In this case, the presentation control unit 77 makes the subject vehicle width guide lines SGLh, SGLm blink several times and then makes them non-displayed (see FIG. 20).

### Display Change Depending on Driver State

The HCU 100 cooperates with the driver monitor 29, and when drowsiness or fatigue of the driver is detected, the HCU 100 urges the driver to stop the subject vehicle Am without requesting the driver to severely perform the lateral position adjustment. The driver state grasping unit 73 detects the driver's drowsiness and fatigue based on the driver status information acquired from the driver monitor 29. When the driver state grasping unit 73 detects that the driver is drowsy or fatigued, the presentation control unit 77 stops the lateral position adjustment assistance using the overlapping guide display HD3 (see FIG. 9).

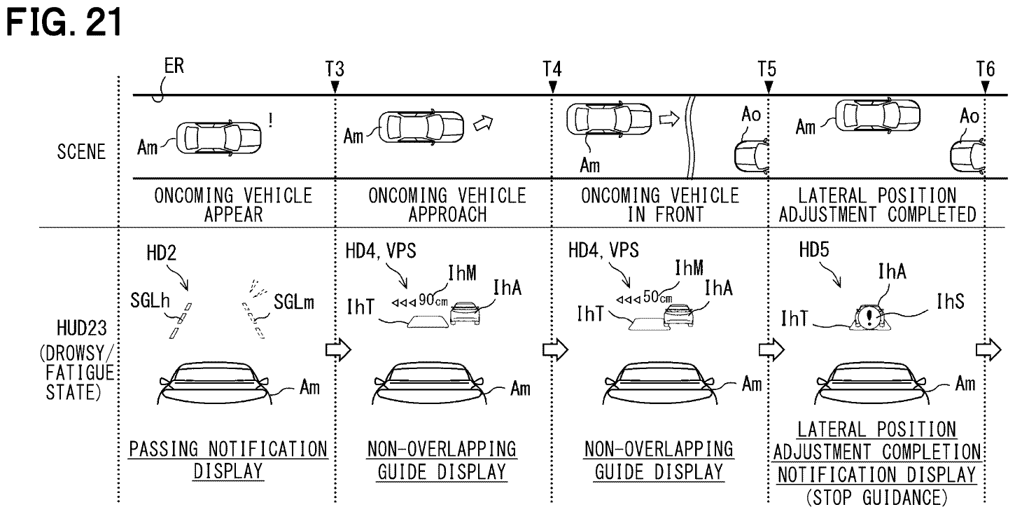

More specifically, the presentation control unit 77 starts the non-overlapping guide display HD4 at the timing T3, and causes the HUD 23 to display the alternative assistance image VPS (see FIG. 21). The alternative assistance image VPS includes the subject vehicle icon IhA, which is substantially the same as the lateral position adjustment assistance icon image VP4 (see FIG. 9), the movement target frame IhT, and the remaining distance meter IhM, and assists the driver in moving the subject vehicle Am over the road.

The external environment information grasping unit 72 provisionally determines that the pulling-over is completed at a timing T5 when the driver has performed the lateral position adjustment of the subject vehicle Am by a predetermined distance. The timing T5 when the driver' drowsiness or fatigue is detected by the driver state grasping unit 73 is a timing before the completion of the lateral position adjustment by the subject vehicle Am. Based on the provisional determination that the lateral position adjustment is completed, the presentation control unit 77 switches the display of the HUD 23 from the non-overlapping guide display HD4 to the lateral position adjustment completion notification display HD5 at the timing T5. In this case, the stop icon IhS is displayed on the lateral position adjustment completion notification display HD5. The stop icon IhS is displayed and overlaps with the subject vehicle icon IhA to guide the subject vehicle Am to stop. The lateral position adjustment completion notification display HD5 including the stop icon IhS can prompt the driver to prioritize stopping over further lateral position adjustment.

### Traveling Assistance Display on Curves

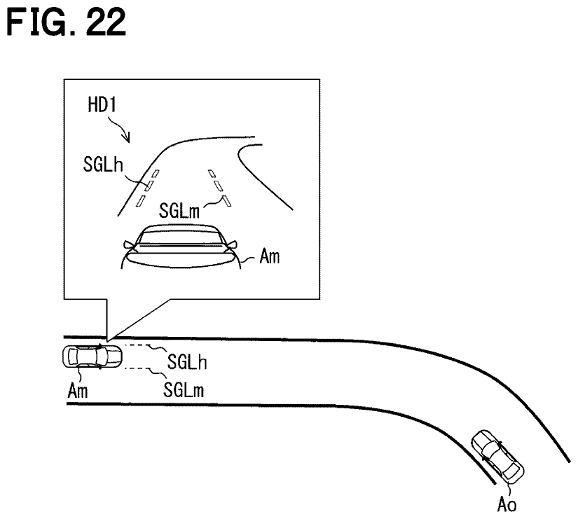

The HCU 100 performs traveling assistance using the subject vehicle width guide display HD1 not only in the narrow road traveling scene but also a scene of traveling on curves with good visibility (see FIG. 22). When there is a curve section ahead of the subject vehicle Am, the external environment information grasping unit 72 grasps whether there is a center line and whether there is the oncoming vehicle Ao traveling beyond the curve section. The external environment information grasping unit 72 grasps whether there is a center line based on, for example, map data or detection information from the front camera unit 31. The external environment information grasping unit 72 determines whether the oncoming vehicle Ao is present based on the detection information from the front camera unit 31 or the millimeter wave radar 32. Furthermore, the external environment information grasping unit 72 grasps the distance to the start point of the curve where the straight section transitions to the curve section, based on the map data and the locator information.

When the external environment information grasping unit 72 grasps that there is no center line in the curve section and that the oncoming vehicle Ao is present, the presentation control unit 77 causes the HUD 23 to display the subject vehicle width guide display HD1 including the subject vehicle width guide lines SGLh, SGLm. The presentation control unit 77 starts displaying the subject vehicle width guide display HD1 at the timing when the subject vehicle Am approaches a position that is a predetermined distance (for example, 50 m) from the start point of the curve. The subject vehicle width guide display HD1 assists the subject vehicle Am in moving to the left in advance, and allows the subject vehicle Am to smoothly pass the oncoming vehicle Ao in the curve section. The subject vehicle width guide display HD1 may end when the subject vehicle Am enters the curve.

### Display Control Process for Narrow Road Traveling Assistance

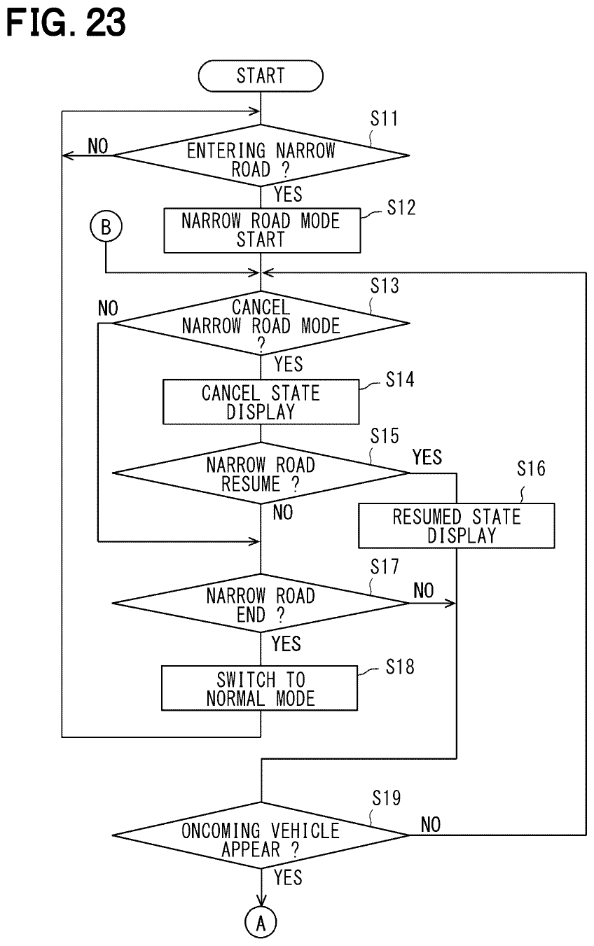

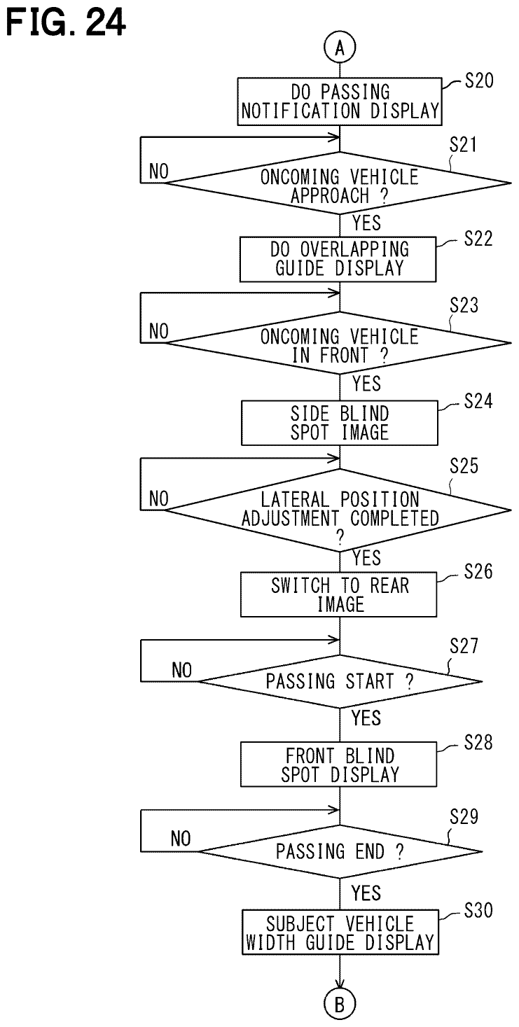

Next, the display control process for implementing the narrow road traveling assistance described above will be described in detail based on FIGS. 23 and 24 with reference to FIGS. 1, 2, and 8 to 11. The display control process is started by the HCU 100, for example, when the subject vehicle Am starts traveling. The display control process is continuously executed by the HCU 100 until the subject vehicle Am stops traveling.

In S11 of the display control process, the external environment information grasping unit 72 determines whether the vehicle is entering the narrow road. When it is not determined that the vehicle has entered the narrow road (S11: NO), the external environment information grasping unit 72 repeats the entry determination. On the other hand, when it is determined that the vehicle has entered the narrow road (S11: YES), the presentation control unit 77 starts the narrow road mode in S12. Thereby, the subject vehicle width guide display HD1 and narrow road mode display MD1 start (see the timing T1 in FIG. 8).

In S13, the presentation control unit 77 determines whether it is necessary to cancel the narrow road mode. When the narrow road mode is cancelled (S13: YES), the presentation control unit 77 displays an animation for the cancellation in S14 (see FIGS. 18 to 20). In this case, the presentation control unit 77 determines in S15 whether it is necessary to resume the narrow road mode. When the narrow road mode is resumed, the presentation control unit 77 displays an animation at the time of resumption in S16 (see the right part in FIG. 18).

When the narrow road mode continues (S13: NO), the presentation control unit 77 determines in S17 whether it is necessary to end the narrow road mode. When the narrow road mode ends (S17: YES), the presentation control unit 77 performs switching from the narrow road mode to the normal mode in S18 (see the timing T8 in FIG. 11). As a result, the subject vehicle width guide display HD1 ends, and the normal mode display MDN starts. In this case, the control flow returns to S11.

When the narrow road mode does not end (S17: NO), in S19, the external environment information grasping unit 72 grasps information about the oncoming vehicle Ao that is the passing target, and determines whether the oncoming vehicle Ao that needs to be avoided has appeared. When the oncoming vehicle Ao has not been detected (S19: NO), the control flow returns to S13. On the other hand, when the oncoming vehicle Ao is detected (S19: YES), the presentation control unit 77 starts the passing notification display HD2 and the oncoming vehicle appearance display MD2 in S20 (see the timing T2 in FIG. 8).

In S21, the external environment information grasping unit 72 determines whether the oncoming vehicle Ao is approaching. When it is determined that the oncoming vehicle Ao is approaching (S21: YES), the presentation control unit 77 starts the overlapping guide display HD3 and the lateral position adjustment guide display MD3 in S22 (see the timing T3 in FIG. 9). In S22, the HUD 23 displays a virtual image of the lateral position adjustment assistance overlapping image VP3 that assists moving in the outward direction of the narrow road.

In S23, the external environment information grasping unit 72 determines whether the oncoming vehicle Ao is approaching closely in front of the subject vehicle Am. When it is determined that the oncoming vehicle Ao is approaching closely (S23: YES), the presentation control unit 77 starts the non-overlapping guide display HD4 as the assistance display immediately before passing in S24 (see the timing T4 in FIG. 9). Furthermore, the presentation control unit 77 causes the meter display 21 to start displaying the side blind spot image MD4. As a result, the external environment image is displayed on the meter display 21 in a state where the passing assistance image RP4 that assists passing overlaps with the camera image CP that shows the road surface in the periphery of the subject vehicle Am.

In S25, the external environment information grasping unit 72 determines whether the lateral position adjustment is completed. When the subject vehicle Am is in a state where it can pass the oncoming vehicle Ao and it is determined that the lateral position adjustment has been completed (S25: YES), the presentation control unit 77 starts the lateral position adjustment completion notification display HD5 in S26 (see the timing T5 in FIG. 10). Furthermore, the presentation control unit 77 switches the content of the external image of the meter display 21 to the rear image MD5 formed by overlapping a trajectory image RP5 showing the movement trajectory of the subject vehicle Am on the camera image CP showing the rear of the vehicle Am.

In S27, the external environment information grasping unit 72 determines the passing start of the oncoming vehicle Ao. When it is determined that the passing has started (S27: YES), the presentation control unit 77 starts the passing situation display HD6 in S28 (see the timing T6 in FIG. 10). Furthermore, the presentation control unit 77 switches the content of the external environment image on the meter display 21 to the front blind spot image MD6.

In S29, the external environment information grasping unit 72 determines whether the passing of the oncoming vehicle Ao has ended. When it is determined that the passing has ended (S29: YES), the presentation control unit 77 ends the passing situation display HD6 and the front blind spot image MD6 in S30, and starts the subject vehicle width guide display HD1 and the narrow road mode display MD1 (see the timing T7 in FIG. 11). In this case, the control flow returns to S13.

### Overview of Embodiment

In the embodiment described so far, when the oncoming vehicle Ao that is the passing target is identified, the HUD 23 displays the lateral position adjustment assistance overlapping image VP3 that assists the lateral position adjustment in the outward direction of the narrow road. In the display, the image VP3 is placed in front of the subject vehicle Am in the overlapping manner. Therefore, the driver can use the lateral position adjustment assistance overlapping image VP3 to prepare in advance for the passing without taking the driver eyes off the road. Furthermore, the driver can start passing the oncoming vehicle Ao by shifting the line of sight to the side blind spot image MD4 displayed on the meter display 21 while checking the actual image in the periphery of the subject vehicle and using the passing assistance image RP4. As described above, by providing the assistance through displays in stages, it becomes possible for the driver to perform the passing smoothly.

Additionally, in the present embodiment, the lateral position adjustment assistance overlapping image VP3 including at least the subject vehicle width guide lines SGLh, SGLm indicating the positions of the outer edges of the subject vehicle Am in the width direction is displayed in the overlapping manner. Therefore, the driver can smoothly start the initial movement of the lateral position adjustment (to the left) using the subject vehicle width guide lines SGLh, SGLm as a guide.

Further, in the present embodiment, the external environment information grasping unit 72 grasps the condition of the outer road edge ER of the narrow road. Then, the lateral position adjustment assistance overlapping image VP3 including the road edge guide lines EGL indicating the position of the road edge ER together with the subject vehicle width guide lines SGLh, SGLm is displayed in the overlapping manner. Furthermore, the overlapping position of the road edge guide line EGL is changed according to the situation of the road edge ER (see FIG. 12). By adjusting the position of the road edge guide line EGL in this way, the driver can perform the lateral position adjustment of the subject vehicle Am to an appropriate position by performing a steering operation to bring the subject vehicle width guide lines SGLh closer to the road edge guide line EGL.

Furthermore, in the present embodiment, the passing assistance image RP4 including at least a road edge highlighting line EEL indicating the position of the road edge ER overlaps with the camera image CP. Therefore, the driver can accurately move the subject vehicle Am to a position close to the road edge ER while checking the road edge highlighting line EEL in the camera image CP. As a result, it is possible to smoothly perform the passing with the oncoming vehicle Ao.

In addition, in the present embodiment, when the road edge ER is in the complex state, the overlapping display of the lateral position adjustment assistance overlapping image VP3 is stopped (see FIG. 14). Therefore, an occurrence of a situation becomes difficult in which the overlapping position of the road edge guide line EGL changes frequently due to the influence of the complex road edge ER and the lateral position adjustment by the driver is prevented.

Further, in the present embodiment, the lateral position adjustment assistance overlapping image VP3 including at least the oncoming vehicle guide line TGL indicating the position of the inner outer edge of the oncoming vehicle Ao is displayed in the overlapping manner. However, when the behavior of the oncoming vehicle Ao is unstable, the display of the oncoming vehicle guide lines TGL is stopped (see FIG. 15). Therefore, an occurrence of a situation becomes difficult in which the overlapping position of the oncoming vehicle guide line TGL changes frequently due to the influence of the unstable oncoming vehicle Ao and the lateral position adjustment by the driver is prevented.

Furthermore, in the present embodiment, based on the recognition of the oncoming vehicle Ao, the passing notification display HD2 is displayed by the HUD 23 prior to the lateral position adjustment assistance overlapping image VP3 (see the right part in FIG. 8). The passing notification display HD2 notifies the driver of the appearance of an oncoming vehicle Ao, and is an image that contains less information than the lateral position adjustment assistance overlapping image VP3. Such a passing notification display HD2 can subtly alert the driver to the risk of the oncoming vehicle Ao and prompt the driver to take preparatory action for the lateral position adjustment at an early stage. As a result, the driver can smoothly start the lateral position adjustment using the lateral position adjustment assistance overlapping image VP3.

In addition, in the present embodiment, when the preceding vehicle larger than the subject vehicle Am is traveling on a narrow road, or when the distance from the subject vehicle Am to the preceding vehicle is less than the following threshold, the overlapping display of the lateral position adjustment assistance overlapping image VP3 is stopped. Based on the above, in a scene where the subject vehicle Am can pass the preceding vehicle by following the preceding vehicle, the occurrence of the situation in which the driver visibility is obstructed by the lateral position adjustment assistance overlapping image VP3 displayed overlapping with the preceding vehicle becomes difficult.

Further, in the present embodiment, when the oncoming vehicle Ao approaches the subject vehicle Am at a speed exceeding the approach threshold, the overlapping display of the lateral position adjustment assistance overlapping image VP3 is stopped (see FIG. 16). Therefore, it is possible to avoid the situation where the display period of the lateral position adjustment assistance overlapping image VP3 is not sufficiently secured.

Furthermore, in the present embodiment, when the oncoming vehicle Ao approaches the subject vehicle Am at a speed exceeding the approach threshold, the HUD 23 displays, in the overlapping manner, the alternative assistance image VPS that assists the lateral position adjustment at the timing T2 (see FIG. 16) earlier than the lateral position adjustment assistance overlapping image VP3. By displaying such the alternative assistance image VPS, it is possible to prompt the driver to start the lateral position adjustment at an earlier timing than usual. As a result, even in the scene where the oncoming vehicle Ao approaches rapidly, the driver can prepare in advance for the passing state.

In addition, in the present embodiment, when the oncoming vehicle Ao approaches the subject vehicle Am at a speed exceeding the approach threshold, the content of the lateral position adjustment completion notification display HD5, which notifies the subject vehicle Am of completion of the lateral position adjustment, is changed according to the size of the oncoming vehicle Ao. As a result of the above, even when it is possible to avoid the oncoming vehicle Ao in the normal state, the passing assistance continues. As a result, the driver is possible to safely pass the oncoming vehicle Ao.

Further, in the present embodiment, in the narrow road mode which starts based on the entry into the narrow road, the HUD 23 displays the subject vehicle width guide display HD1 which indicates that the subject vehicle is traveling on the narrow road. That is, the expression for removing this subject vehicle width guide display HD1 is changed in the interruption scene where the road width of the narrow road temporarily widens and the end scene where the narrow road ends (see FIGS. 4 and 18). According to the above, the driver is possible to know whether the narrow road is scheduled to restart from the animation of disappearing the subject vehicle width guide display HD1. Therefore, the driver is possible to appropriately select an action such as moving the subject vehicle Am to a place where the road width temporarily widens and passing the oncoming vehicle Ao.

Furthermore, in the present embodiment, when the narrow road mode is cancelled during the travelling on the narrow road, the expression for removing the subject vehicle width guide display HD1 is changed depending on the reason for the cancellation. Therefore, the driver is possible to understand the reason for the cancellation of the narrow road mode from the manner in which the subject vehicle width guide display HD1 is removed. As a result, the driver is possible to appropriately select the action to address the cancellation reason.

In addition, in the present embodiment, when the meter display 21 displays the side blind spot image MD4, the lateral position adjustment assistance icon image VP4 is displayed in place of the lateral position adjustment assistance overlapping image VP3. The lateral position adjustment assistance icon image VP4 is an image that assists the lateral position adjustment using the subject vehicle icon IhA indicating the subject vehicle Am. According to the above, even after the passing place is outside the angle of view of the HUD 23, the lateral position adjustment assistance continues by the lateral position adjustment assistance icon image VP4. Therefore, together with the display of the side blind spot image MD4, the driver is possible to perform the lateral position adjustment of the subject vehicle Am with respect to the road edge ER with high accuracy.

In the present embodiment, when the subject vehicle Am is in the state where it can pass the oncoming vehicle Ao, the display on the meter display 21 is switched from the side blind spot image MD4 to the rear image MD5. The rear image MD5 is an external image obtained by overlapping the trajectory image RP5 showing the movement trajectory of the subject vehicle Am with the camera image CP showing the rear of the subject vehicle Am. By displaying the rear image MD5 in this way, the driver is possible to confirm that the subject vehicle Am has the attitude parallel to the road edge ER, based on the trajectory image RP5.

Furthermore, in the present embodiment, when the subject vehicle Am starts to pass the oncoming vehicle Ao, the content of the external image on the meter display 21 is switched to the front blind spot image MD6 including the camera image CP showing the blind spot range in front of the subject vehicle Am. According to the above, the driver is possible to check the progress of passing while checking the actual image in real time. As a result, the driver is possible to pass the oncoming vehicle Ao without worry.

Additionally, in the present embodiment, the driver state grasping unit 73 grasps the state of the driver of the subject vehicle Am. When the driver's drowsiness or fatigue is detected by the driver state grasping unit 73, the stop icon IhS instructing the driver to stop is displayed by the HUD 23 before the subject vehicle Am completes the lateral position adjustment of the subject vehicle Am. According to the above, severe guidance for the lateral position adjustment is stopped when the driver is drowsy or fatigued. In this way, by encouraging the driver to stop without forcing the driver to do the sever operation, it becomes possible for the driver to pass smoothly even when the driver state is not good.

In the present embodiment, after the subject vehicle Am is in the state where it can pass the oncoming vehicle Ao, the instruction output unit 75 starts folding of the side mirrors of the subject vehicle Am. The side mirrors are not folded until the vehicle is able to pass. Therefore, the driver is possible to check the state of the lateral position adjustment by using the side mirror. Furthermore, by folding the side mirrors, it is possible to smoothly perform the passing with oncoming vehicle Ao.

In the above embodiment, the meter display 21 and the CID 22 correspond to a “screen display device”, the instruction output unit 75 corresponds to a “mirror folding unit”, the presentation control unit 77 corresponds to a “display control unit”, and the HCU 100 corresponds to a “display control device”. In addition, the camera image CP corresponds to a “captured image”, the subject vehicle width guide display HD1 corresponds to a “narrow road traveling image”, the passing notification display HD2 corresponds to a “passing notification image”, and the lateral position adjustment completion notification display HD5 corresponds to a “completion notification image”. Furthermore, the stop icon IhS corresponds to a “stop guide image”, the side blind spot image MD4 corresponds to an “external environment image”, and the passing assistance image RP4 corresponds to a “second assistance image”. The lateral position adjustment assistance overlapping image VP3 corresponds to a “first assistance image,” and the lateral position adjustment assistance icon image VP4 corresponds to an “icon assistance image.”

### Other Embodiments

Although one embodiment of the present disclosure has been described above, the present disclosure is not construed as being limited to the embodiment described above, and can be applied to various embodiments and combinations within a scope that does not depart from the gist of the present disclosure.

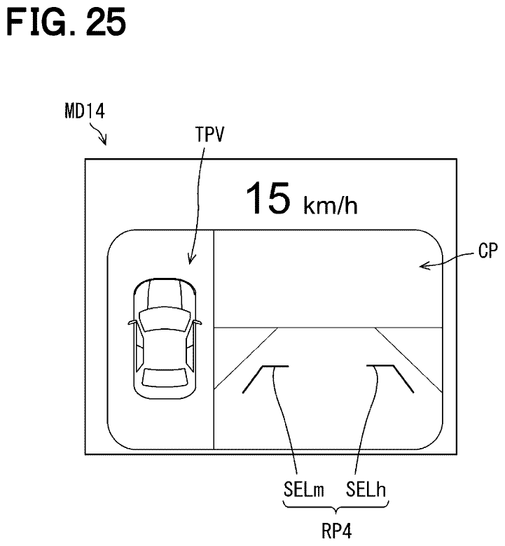

In a first modification of the above embodiment, at the timing T4 when the oncoming vehicle Ao is approaching, the periphery monitoring image MD14 shown in FIG. 25 is displayed on the meter display 21 instead of the side blind spot image MD4. The periphery monitoring image MD14 has substantially the same display content as the front blind spot image MD6 in the above embodiment, and is an external image including the top-view image TPV and the camera image CP captured by the front camera of the surround camera system 33. The passing assistance image RP4 with which the camera image CP overlaps includes the vehicle width highlighting lines SELh, SELm which indicate the positions of the outer edges of the subject vehicle Am in the width direction. The vehicle width highlighting lines SELh, SELm are drawn in the same color as or a similar color (for example, green) to the subject vehicle width guide lines SGLh, SGLm. The periphery monitoring image MD14 continues to be displayed on the meter display 21 until the timing T7 when the passing is completed.

In such a first modification, the vehicle width highlighting lines SELh, SELm having the same function as the subject vehicle width guide lines SGLh, SGLm (see FIG. 5) displayed by the HUD 23 are also displayed on the meter display 21. Therefore, even when the driver shifts the line of sight from the front to the screen of the meter display 21 when transitioning from a scene where the passing condition is created in advance to the actually passing scene, the driver is possible to easily understand the contents of the display. As a result, the step-by-step display assistance enables the driver to smoothly perform the passing.

In addition, in the periphery monitoring video MD14 of the first modification, the camera image CP may overlap with the passing assistance image RP4 that further includes image portions corresponding to the oncoming vehicle highlighting line TEL and the road edge highlight line EEL. Furthermore, the top-view image TPV may overlap with this passing assistance image RP4.

In a second modification of the above embodiment, the HUD 23 having a narrower angle of view than that of the above embodiment is used, and AR display is not performed. In this second modification, the lateral position adjustment assistance by the non-overlapping guide display starts at the timing T3. In this case, non-overlapping content that is substantially the same as the lateral position adjustment assistance icon image VP4 is displayed by the HUD 23 as a “first assistance image” from the timing T3.

In the above embodiment, the meter display 21 displays a digital speedometer SM, and the HUD 23 displays a remaining distance meter IhM (see the right column in FIG. 9). In this way, when two numerical values are displayed at the same time, it may confuse the driver. Therefore, in a third modification of the above embodiment, the presentation control unit 77 changes the appearance of the digital speedometer SM in the narrow road mode. Specifically, in the normal mode, the presentation control unit 77 displays numbers indicating the vehicle speed on the digital speedometer SM. On the other hand, in the narrow road mode, the presentation control unit 77 switches the digital speedometer SM to an image of a speedometer that displays a needle. As a result, even when a numerical value is displayed on the remaining distance meter IhM, the driver is unlikely to become confused.

The processor 11 provided in the HCU 100 of the above embodiment is hardware for arithmetic processing that is coupled with a RAM. The processor 11 includes at least one arithmetic core, such as a central processing unit (CPU) or a graphics processing unit (GPU). The processor 11 may further include, for example, a field-programmable gate array (FPGA) and an IP core having other dedicated functions.

The storage 13 includes a non-volatile storage medium (non-transitory tangible computer-readable storage medium). Such a storage medium is not limited to the configuration provided on the circuit board, and may be provided in the form of a memory card or the like. The storage medium may be inserted into a slot portion, and electrically connected to the control circuit of the HCU 100. Further, the storage medium may be an optical disc, a hard disk drive, or the like used as a source of copying or distributing a program to the storage 13.

In the above embodiment, each function provided by the HCU 100 may be implemented in the control circuit of each display device. In such an embodiment, the display device corresponds to the “display control device”. Further, the respective functions provided by the HCU 100 can be also provided by software and hardware for executing the software, only software, only hardware, and complex combinations of software and hardware. Further, when such functions are provided by electronic circuits as hardware, each function can be provided by a digital circuit including a large number of logic circuits, or an analog circuit.

The vehicle equipped with the above-described display system is not limited to a general private car, but may be a rented vehicle, a vehicle for man-driving taxi, a vehicle for sharing vehicle service, a freight vehicle, a bus, or the like. Further, the vehicle equipped with the display system may be a right-hand drive vehicle or a left-hand drive vehicle. Further, the traffic environment in which the vehicle travels may be a traffic environment premised on left-hand traffic, or may be a traffic environment premised on right-hand traffic. According to the present disclosure, the display control may be appropriately optimized according to the road traffic law of each country and region, the steering wheel position of the vehicle, and the like.

The controller and the method thereof described in the present disclosure may be implemented by a dedicated computer, which includes a processor programmed to execute one or more functions performed by computer programs. Alternatively, the device and the method thereof according to the present disclosure may be implemented by a dedicated hardware logic circuit. Alternatively, the device and the method thereof according to the present disclosure may be implemented by one or more dedicated computers implemented by a combination of a processor that executes a computer program and one or more hardware logic circuits. The computer program may also be stored on a computer-readable and non-transitory tangible storage medium as an instruction executed by a computer.

What is claimed is:

1. A display control device that is used in a vehicle that provides display assistance for passing an oncoming vehicle on a narrow road, the device comprising:
a display control unit configured to control display by a screen display device and a head-up display; and
an external environment information grasping unit configured to grasp information of the oncoming vehicle that is a passing target when a subject vehicle that is the vehicle travels on the narrow road,
wherein
the display control unit is configured to:
when the oncoming vehicle is grasped, cause the head-up display to perform overlapping display of a first assistance image with a foreground of the subject vehicle, the first assistance image assisting a driver in lateral position adjustment in an outward direction of the narrow road; and
after the first assistance image is displayed, display, on the screen display device, an external environment image in which a second assistance image that assists passing overlaps with a capture image showing a road surface in a periphery of the subject vehicle.

2. The display control device according to claim 1, wherein
the display control unit is configured to perform the overlapping display of the first assistance image including at least a subject vehicle width guide line indicating a position of an outer edge in a width direction of the subject vehicle.

3. The display control device according to claim 2, wherein
the display control unit is configured to overlap the second assistance image with the captured image, the second assistance image including at least a subject vehicle width highlighting line that indicates a position of an outer edge of the subject vehicle in a width direction.

4. The display control device according to claim 2, wherein
the external environment information grasping unit grasps a situation of a road edge in the outward direction toward an outside of the narrow road,
the display control unit is configured to:
perform the overlapping display of the first assistance image including a road edge guide line indicating a position of the road edge together with the subject vehicle width guide line; and
change an overlapping position of the road edge guide line depending on a situation of the road edge.

5. The display control device according to claim 4, wherein
the display control unit overlaps the second assistance image with the captured image, the second assistance image including at least a road edge highlighting line that indicates a position of the road edge.

6. The display control device according to claim 1, wherein
the external environment information grasping unit grasps a situation of a road edge in the outward direction toward an outside of the narrow road, and
the display control unit stops the overlapping display of the first assistance image when the road edge is in a complex state.

7. The display control device according to claim 1, wherein
the display control unit is configured to:
perform the overlapping display of the first assistance image including at least an oncoming vehicle guide line that indicates a position of an outer edge in an inward direction of the oncoming vehicle; and
when a behavior of the oncoming vehicle is unstable, stop displaying the oncoming vehicle guide line.

8. The display control device according to claim 1, wherein
the display control unit is configured to:
provide notification indicating an appearance of the oncoming vehicle based on recognition of the oncoming vehicle; and
cause the head-up display to display a passing notification image prior to the first assistance image, and
an information amount of the passing notification image is less than an information amount of the first assistance image.

9. The display control device according to claim 1, wherein
the display control unit stops the overlapping display of the first assistance image in at least one of a case where a preceding vehicle larger than the subject vehicle is traveling on the narrow road or a case where a vehicle-to-vehicle distance from the subject vehicle to the preceding vehicle is less than a following threshold.

10. The display control device according to claim 1, wherein
the display control unit stops the overlapping display of the first assistance image when the oncoming vehicle approaches the subject vehicle at a speed exceeding an approach threshold.

11. The display control device according to claim 10, wherein
when the oncoming vehicle approaches the subject vehicle at a speed exceeding the approach threshold, the display control unit causes the head-up display to perform the overlapping display of an alternative assistance image that assists the lateral position adjustment earlier than the first assistance image.

12. The display control device according to claim 10, wherein
the display control unit changes a content of a completion notification image notifying completion of the lateral position adjustment when the oncoming vehicle approaches the subject vehicle at a speed exceeding the approach threshold, depending on a size of the oncoming vehicle.

13. The display control device according to claim 1, wherein
the display control unit is configured to:
in a narrow road mode that starts based on an entry into the narrow road, cause the head-up display to display a narrow road traveling image showing traveling on the narrow road; and
change an expression for removing the narrow road traveling image in a different manner between an interruption scene in which a road width of the narrow road temporarily widens and an end scene in which the narrow road ends.

14. The display control device according to claim 13, wherein,
when the narrow road mode is cancelled during travelling on the narrow road, the display control unit changes the expression for removing the narrow road traveling image according to a reason for cancellation of the narrow road mode.

15. The display control device according to claim 1, wherein
together with display of the external environment image by the screen display device, the display control unit displays an icon assistance image that assists the lateral position adjustment using a subject vehicle icon representing the subject vehicle in place of the first assistance image.

16. The display control device according to claim 1, wherein
when the subject vehicle is in a state where the subject vehicle is possible to pass the oncoming vehicle, the display control unit switches a content of the external environment image to a rear image obtained by overlapping a trajectory image showing a movement trajectory of the subject vehicle with the capture image showing a rear of the subject vehicle.

17. The display control device according to claim 1, wherein
the display control unit switches a content of the external environment image to a front blind spot image including the capture image showing a blind spot range in front of the subject vehicle based on a start of passing between the subject vehicle and the oncoming vehicle.

18. The display control device according to claim 1, further comprising
a driver state grasping unit configured to grasp a driver state of the subject vehicle,
wherein
when drowsiness or fatigue of the driver is detected by the driver state grasping unit, the display control unit causes the head-up display to display a stop guide image that guides the driver to stop the subject vehicle before completion of the lateral position adjustment by the subject vehicle.

19. The display control device according to claim 1, further comprising
a mirror folding unit configured to start folding a side mirror of the subject vehicle after the subject vehicle is in a state where the subject vehicle is possible to pass the oncoming vehicle.

20. A non-transitory computer-readable storage medium storing a display control program that is used in a vehicle that provides display assistance for passing an oncoming vehicle on a narrow road, the program being configured to:
grasp information of the oncoming vehicle that is a passing target when a subject vehicle that is the vehicle travels on the narrow road;
when the oncoming vehicle is grasped, cause a head-up display to perform overlapping display of a first assistance image with a foreground of the subject vehicle, the first assistance image assisting a driver in lateral position adjustment in an outward direction of the narrow road; and
after the first assistance image is displayed, display, on a screen display device, an external environment image in which a second assistance image that assists passing overlaps with a capture image showing a road surface in a periphery of the subject vehicle.

21. A display control device that is used in a vehicle that provides display assistance for passing an oncoming vehicle on a narrow road, the device comprising:
a processor; and
a memory coupled to the processor and storing program instructions that when executed by the processor cause the processor to at least:
control display by a screen display device and a head-up display;
grasp information of the oncoming vehicle that is a passing target when a subject vehicle that is the vehicle travels on the narrow road;
when the oncoming vehicle is grasped, cause the head-up display to perform overlapping display of a first assistance image with a foreground of the subject vehicle, the first assistance image assisting a driver in lateral position adjustment in an outward direction of the narrow road; and
after the first assistance image is displayed, display, on the screen display device, an external environment image in which a second assistance image that assists passing overlaps with a capture image showing a road surface in a periphery of the subject vehicle.
